(19) United States
(12) Patent Application Publication
(10) Pub. No.: US 2025/0376554 A1
(43) Pub. Date: Dec. 11, 2025

(54) HIGHLY ALKALI-STABLE POLY(ARYLENE ALKYLENE PIPERIDINIUM) CATIONIC POLYMER HAVING BRANCHED STRUCTURE, AND PREPARATION METHOD AND USE THEREOF

(71) Applicant: Hefei University of Technology, Hefei (CN)

(72) Inventors: Haibing Wei, Hefei (CN); Lan Zhang, Hefei (CN); Tao Wang, Hefei (CN)

(73) Assignee: Hefei University of Technology, Hefei (CN)

(21) Appl. No.: 19/301,195

(22) Filed: Aug. 15, 2025

(30) Foreign Application Priority Data
Aug. 16, 2024 (CN) 202411128851.4

(51) Int. Cl. C08G 10/02

(52) U.S. Cl. CPC C08G 10/02; C08G 2261/1426; C08G 2261/143; C08G 2261/1452; C08G 2261/146; C08G 2261/312; C08G 2261/3142; C08G 2261/90

(57) ABSTRACT

The present disclosure relates to the field of cationic polymers, and in particular to highly alkali-stable poly(arylene alkylene piperidinium) cationic polymers having branched structures, and the preparation method and application thereof. The highly alkali-stable poly(arylene alkylene piperidinium) cationic polymers having branched structures include one or more of a central unit, a linear unit L₁, and a linear unit L₂, where the central unit includes one or more of an MA unit, a piperidinium group (m-DMP) and a CA unit, the linear unit L₁ includes the piperidinium group (m-DMP) and a BA unit, and the linear unit L₂ includes a BA unit and a CA unit. The disclosure employs the aforementioned steps to enhance the intermolecular interactions and increase the molecular weight of the polymer through a branching strategy.

### TECHNICAL FIELD

The present disclosure relates to the field of cationic polymers, and in particular to highly alkali-stable poly(arylene alkylene piperidinium) cationic polymers having branched structures, and the preparation methods and applications.

### BACKGROUND

The efficient development and utilization of hydrogen energy is an important means to address the current environmental issues and energy crisis. Anion exchange membrane water electrolysis (AEMWE) and anion exchange membrane fuel cell (AEMFC) possess the advantages of low cost and high efficiency, serving as crucial means for development and utilization of green hydrogen. However, the alkaline operation environment of the AEMFC and the AEMWE poses a new challenge to stability of the polymer electrolyte, especially the cationic functional groups in the polymer electrolyte. Attention has been extensively paid to the piperidinium cation with outstanding alkali resistance and easy link to a polyaromatic main chain. Poly(aryl-piperidinium) cationic polymers having a 4-position piperidinium group connected to an aryl unit have been extensively studied for the simple synthetic methods and excellent performance, and has been commercialized on a small scale. However, on the other hand, when the piperidinium ring is directly linked to an aryl unit, resulting in a deterioration in the alkaline stability of the pyridinium group (ChemSusChem, 2024, 17, e202301656).

Moreover, the polymer electrolyte used in AEMWE and AEMFC has been faced with a dilemma of trade-off between conductivity and water absorption. In a case that the polymer electrolyte has high ion exchange capacity, its ion conductivity is increased, thus improving device efficiency. However, excessive water uptake swelling of the polymer electrolyte at a high temperature is caused by the high ion exchange capacity, resulting in mechanical deformations. As a result, stable operation of the AEMFC and the AEMWE cannot be guaranteed, and degradation could give rise to safety issues. Solving this trade-off dilemma is crucial to the development of advanced polymer electrolytes.

### SUMMARY

The purpose of the present disclosure is to provide highly alkali-stable poly(arylene alkylene piperidinium) cationic polymers having branched structures, and the preparation methods and applications. The disclosed highly alkali-stable poly(arylene alkylene piperidinium) cationic polymers having branched structures improve mechanical and chemical stabilities of an anion exchange membrane and a catalyst layer binder when being used in the anion exchange membrane and the catalyst layer binder.

In order to achieve the above objective, the present disclosure provides highly alkali-stable poly(arylene alkylene piperidinium) cationic polymers having branched structures. The highly alkali-stable poly(arylene alkylene piperidinium) cationic polymers having branched structures includes one or more of a central unit, a linear unit L₁, or a linear unit L₂, where the central unit includes one or more of the MA unit, the piperidinium group (m-DMP), or the CA unit, the linear unit L₁ includes the piperidinium group (m-DMP) and the BA unit, and the linear unit L₂ includes the BA unit and the CA unit; and
the piperidinium group (m-DMP) has a structural formula of

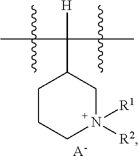

where R¹ and R² are independently selected from hydrocarbyl groups having the number of carbon atoms ranging from 1 to 20, alternatively, R¹ and R² are connected to each other to form a cycloalkyl group consisting of 4 to 7 carbon atoms, and a counter ion A⁻ is selected from one or more of halide ions, a methyl sulfate ion, a hydroxide ion or a bicarbonate ion.

Preferably, the MA unit includes 2 to 6 aromatic rings, and is independently selected from one or more of the following structures:

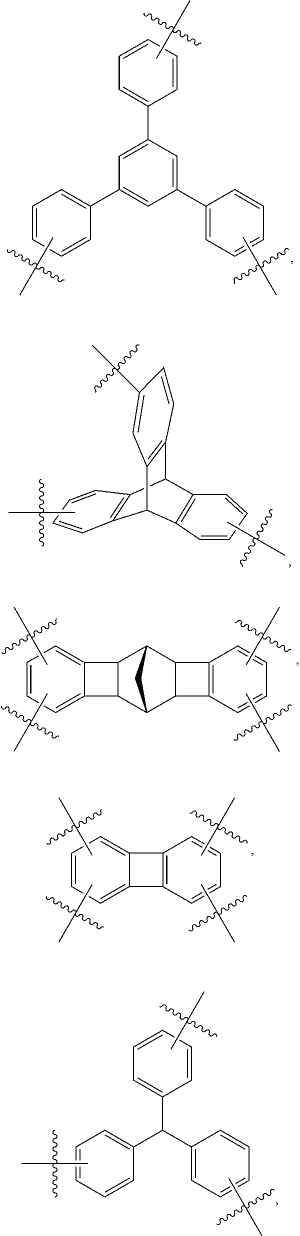

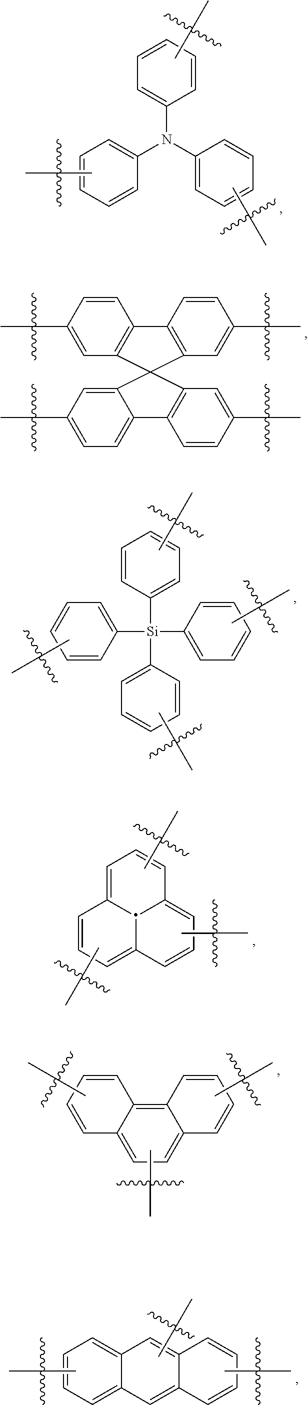

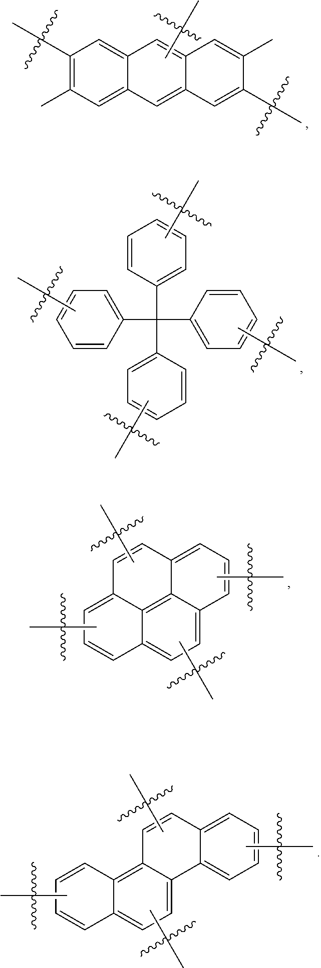

Preferably, the BA unit is independently selected from one or more of the following structures:

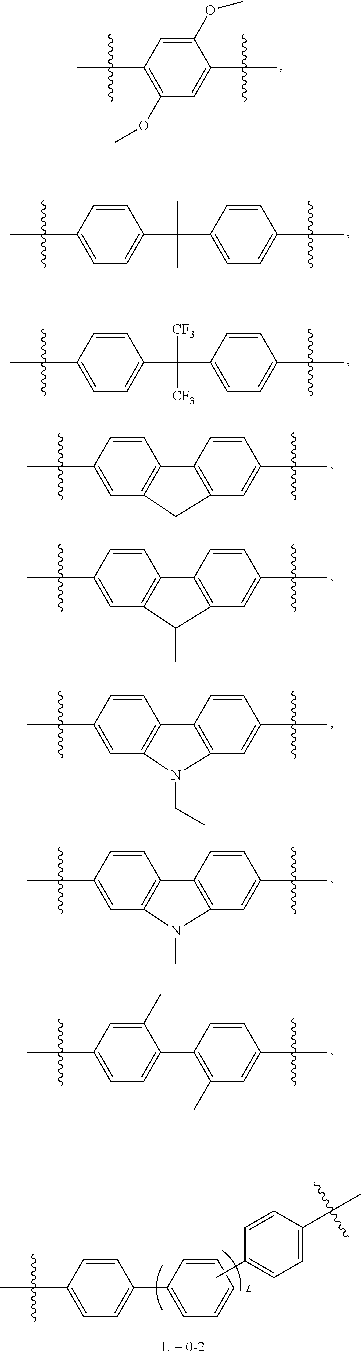

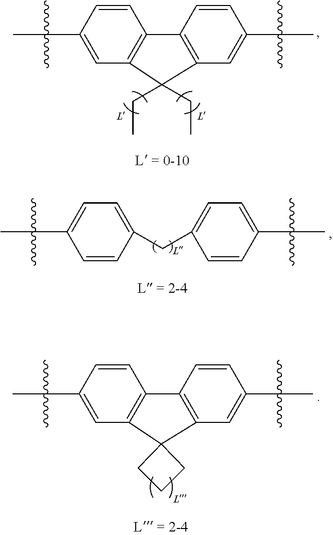

Preferably, the CA unit includes one or more of

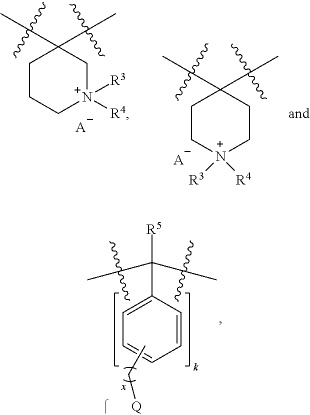

where R³ and R⁴ are independently selected from hydrocarbyl groups having the number of carbon atoms ranging from 1 to 20, and alternatively, R³ and R⁴ are connected to each other to form a cycloalkyl group consisting of 4 to 7 carbon atoms; each R⁵ is independently selected from a hydrogen atom, a hydrocarbyl group having the number of carbon atoms ranging from 1 to 20, or a fully or partially fluorinated alkyl group having the number of carbon atoms ranging from 1 to 6;
k=0 or 1; x=0 to 12; Q is selected from one or more of a hydrogen atom, —N⁺(R⁶)₃, or nitrogen-containing heterocyclic cations; and each R⁶ is independently selected from a hydrocarbyl group having the number of carbon atoms ranging from 1 to 20 in —N⁺(R⁶)₃.

Preferably, the nitrogen-containing heterocyclic cation includes one or more of partially or fully substituted pyrazolium, pyrrolidinium, piperidinium, imidazolium, or quinuclidinium groups with the following structures:

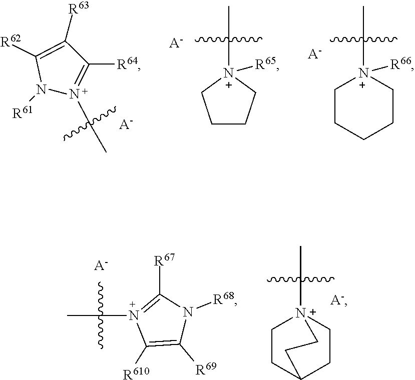

where R⁶¹ to R⁶¹⁰ are independently selected from hydrocarbyl groups having the number of carbon atoms ranging from 1 to 20, and the counter ion A⁻ is selected from one or more of halide ions, a methyl sulfate ion, a hydroxide ion or a bicarbonate ion.

Preferably, the central unit is connected to the linear unit L₁, and the central unit includes the MA unit and the piperidinium group (m-DMP), and has a structural formula shown as follows:

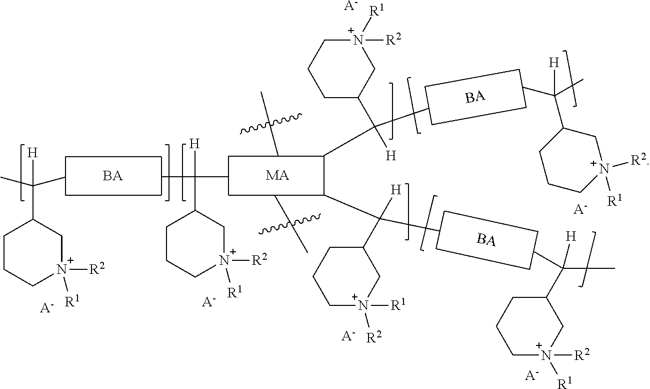

Preferably, the linear unit L₁ is connected to the central unit and the linear unit L₂, and the central unit includes the MA unit, the piperidinium group (m-DMP) and the CA unit, and has a structural formula shown as follows:

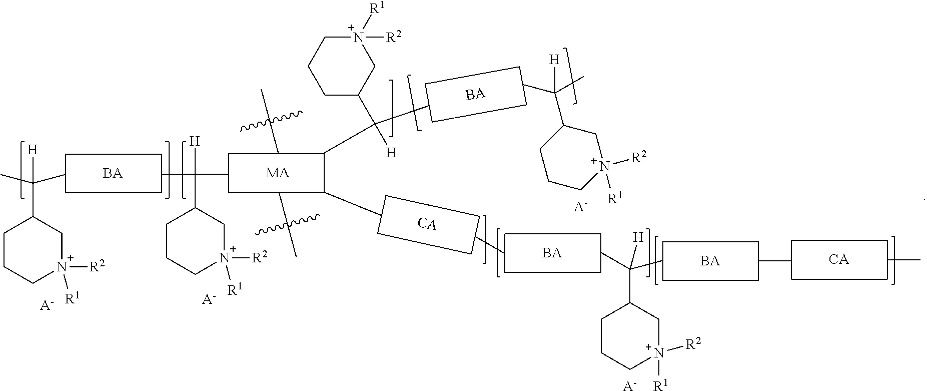

A preparation method of the above highly alkali-stable poly(arylene alkylene piperidinium) cationic polymers having branched structures includes:

S1, mixing raw materials MA′, 1-R⁷ piperidine-3-formaldehyde or salt or a hydrate of 1-R⁷ piperidine-3-formaldehyde, and BA′, dissolving or dispersing the raw materials in the first organic solvent, and performing polycondensation reaction under catalysis of an organic strong acid at −20° C. to 100° C. for 0.1 h to 200 h to obtain a solution or a dispersion of a polyaromatic polymer precursor containing piperidine moieties.

Preferably, the molar ratio of 1-R⁷ piperidine-3-formaldehyde or the salt or the hydrate of the 1-R⁷ piperidine-3-formaldehyde to the organic strong acid is 1:(1-20) in S1.

The polyaromatic polymer precursor containing piperidine moieties has a structural formula shown as follows:

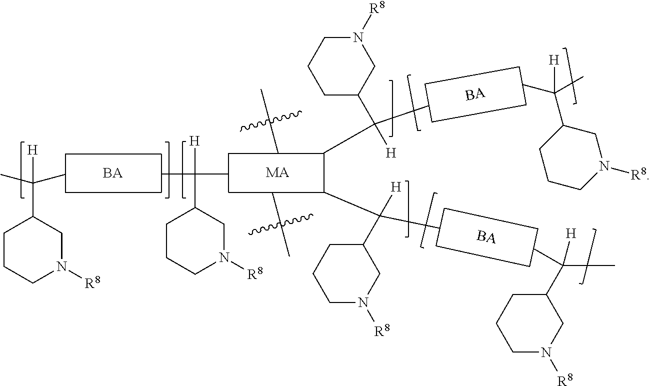

The MA unit is a multisubstituted aromatic unit, the BA unit is a disubstituted aromatic unit, and R⁸ is independently selected from a hydrogen atom or a hydrocarbyl group having the number of carbon atoms ranging from 1 to 20.
S2, dropwise adding the solution or the dispersion of the polyaromatic polymer precursor containing piperidine moieties obtained in S1 into the first precipitant slowly, filtering a precipitate after precipitation to obtain a fibrous polymer, washing the fibrous polymer completely and drying to obtain a polyaromatic polymer precursor containing piperidine moieties;
S3, dispersing or dissolving the polyaromatic polymer precursor containing piperidinium moieties obtained in S2 in a second organic solvent, adding quaternization reagents into the mixture, and then performing a quaternization reaction at 0° C. to 100° C. for 0.1 h to 200 h to obtain a solution or a dispersion of highly alkali-stable poly(arylene alkylene piperidinium) cationic polymers having branched structures; and
S4, slowly adding the solution or the dispersion of the highly alkali-stable poly(arylene alkylene piperidinium) cationic polymers having branched structures obtained in S3 into a second precipitant, and filtering and drying the precipitate after precipitation to obtain the highly alkali-stable poly(arylene alkylene piperidinium) cationic polymers having branched structures.

A preparation method of the above highly alkali-stable poly(arylene alkylene piperidinium) cationic polymers having branched structures includes:

S1, dissolving or dispersing raw materials MA′, 1-R⁷ piperidine-3-formaldehyde or salt or a hydrate of 1-R⁷ piperidine-3-formaldehyde, BA′ and a compound CA″ in the first organic solvent, and performing polycondensation reaction under catalysis of an organic strong acid at −20° C. to 100° C. for 0.1 h to 200 h to obtain a solution or a dispersion of a polyaromatic polymer precursor containing piperidine moieties.

Preferably, the molar ratio of an aldehyde-containing compound and 1-R⁷ piperidine-3-formaldehyde or the salt or the hydrate of the 1-R⁷ piperidine-3-formaldehyde to the organic strong acid is 1:(1-20) in S1.

The polyaromatic polymer precursor containing piperidinium moieties has a structural formula shown as follows:

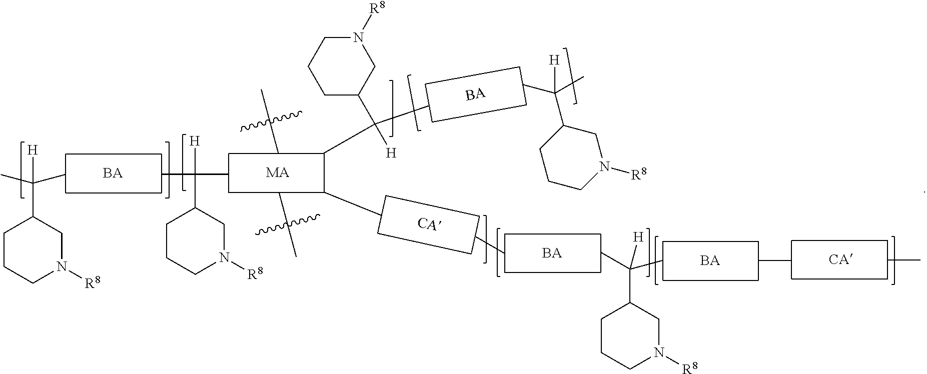

The MA unit is a multisubstituted aromatic unit, the BA unit is a disubstituted aromatic unit, and R⁸ is independently selected from a hydrogen atom or a hydrocarbyl group having the number of carbon atoms ranging from 1 to 20.
S2, dropwise adding the solution or the dispersion of the polyaromatic polymer precursor containing piperidine moieties obtained in S1 into the first precipitant slowly, filtering a precipitate after precipitation to obtain a fibrous polymer, washing the fibrous polymer completely, and drying to obtain a polyaromatic polymer precursor containing piperidine moieties;
S3, dispersing or dissolving the polyaromatic polymer precursor containing piperidine moieties obtained in S2 in a second organic solvent, adding quaternization reagents into the mixture, and then performing a quaternization reaction at 0° C. to 100° C. for 0.1 h to 200 h to obtain a solution or a dispersion of highly alkali-stable poly(arylene alkylene piperidinium) cationic polymers having branched structures; and
S4, slowly adding the solution or the dispersion of the highly alkali-stable poly(arylene alkylene piperidinium) cationic polymers having branched structures obtained in S3 into a second precipitant, and filtering and drying a precipitate after precipitation to obtain the highly alkali-stable poly(arylene alkylene piperidinium) cationic polymers having branched structures.

Preferably, in S1, MA′ is an aryl compound containing 2 to 6 aromatic rings, and is independently selected from one or more of the following structures:

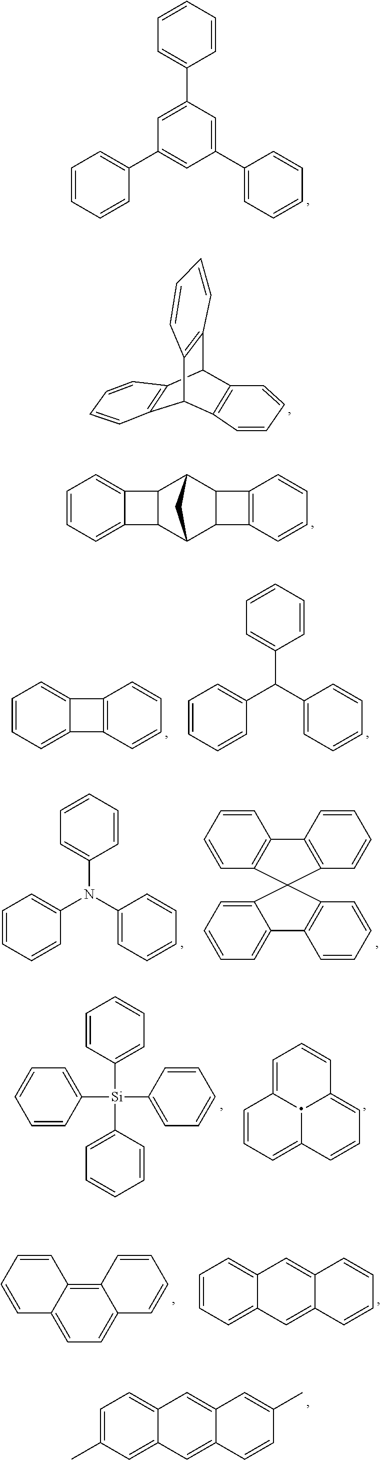

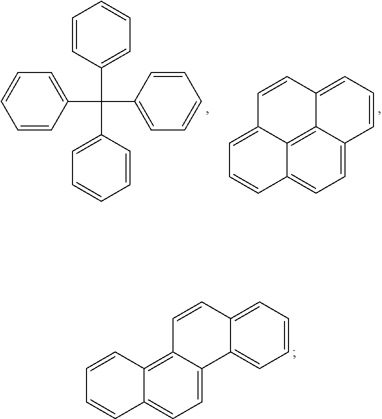

BA′ is independently selected from one or more of the following structures:

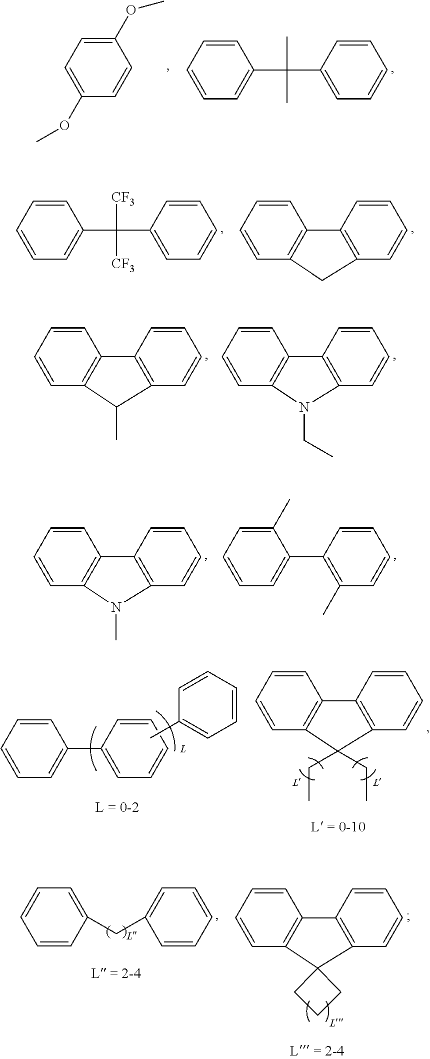

and
1-R⁷ piperidine-3-formaldehyde is

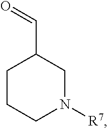

selecting from one or more of the following structures:

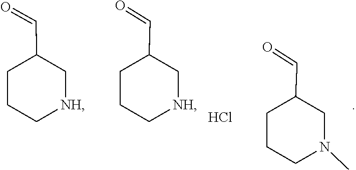

Preferably, the compound CA″ is one or more of

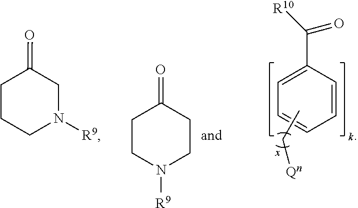

R⁹ is independently selected from a hydrogen atom or a hydrocarbyl group having the number of carbon atoms ranging from 1 to 20; k=0 or 1; x=0 to 12; each R¹⁰ is independently selected from a hydrogen atom or a hydrocarbyl group having the number of carbon atoms ranging from 1 to 20, or a fully or partially fluorinated alkyl group having the number of carbon atoms ranging from 1 to 6; and Q″ is selected from one or more of a hydrogen atom and a halogen atom.

Preferably, the CA′ unit is one or more of

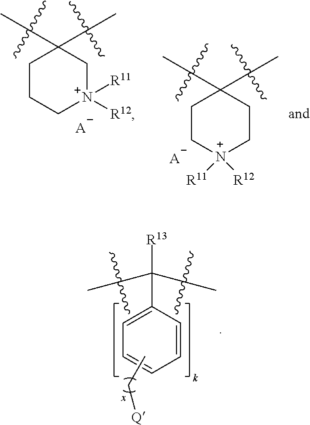

R¹¹ and R¹² are independently selected from a hydrogen atom or hydrocarbyl groups having the number of carbon atoms ranging from 1 to 20; each R¹³ is independently selected from a hydrogen atom or a hydrocarbyl group having the number of carbon atoms ranging from 1 to 20, or a fully or partially fluorinated alkyl group having the number of carbon atoms ranging from 1 to 6; k=0 or 1; x=0 to 12; and Q′ is selected from one or more of a hydrogen atom and a halogen atom.

Preferably, the molar ratio of MA′ to BA′ is 0.001 to 0.3 in S1.

Preferably, the first organic solvent includes one or more of dichloromethane, chloroform, carbon tetrachloride, dichloroethane, nitromethane, or nitrobenzene in S1.

Preferably, the organic strong acid includes one or more of trifluoromethanesulfonic acid, pentafluoroethanesulfonic acid, heptafluoro-1-propanesulfonic acid, trifluoroacetic acid, perfluoropropionic acid, heptafluorobutyric acid, or methanesulfonic acid in S1.

Preferably, the first precipitant includes one or more of water, ethanol, methanol, or isopropanol in S2.

Preferably, in S3, the quaternization agent is one or more of dimethyl sulfate, halogenated hydrocarbons having the number of carbon atoms ranging from 1 to 20, N(R¹⁴)₃, or heterocyclic nitrogen; each R¹⁴ is independently selected from a hydrocarbyl group having the number of carbon atoms ranging from 1 to 20 in N(R¹⁴)₃, and the heterocyclic nitrogen includes one or more of partially or fully substituted pyrazole, pyrrolidinium, piperidine, imidazolium, or quinuclidinium, and has a structure as follows:

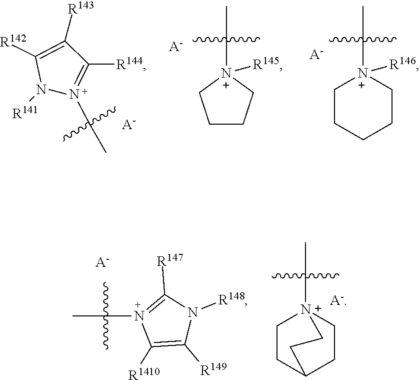

Each substituent group of R¹⁴¹ to R¹⁴¹⁰ is independently selected from a hydrocarbyl group having the number of carbon atoms ranging from 1 to 20.

Preferably, the second organic solvent includes one or more of polar aprotic solvents including dimethyl sulfoxide, N-methylpyrrolidone, N, N-dimethylacetamide, or N, N-dimethylformamide in S3.

Preferably, the second precipitant includes one or more of water, acetone, diethyl ether, toluene, ethyl acetate, or petroleum ether in S4.

An application of the above highly alkali-stable poly(arylene alkylene piperidinium) cationic polymers having branched structures is provided. The highly alkali-stable poly(arylene alkylene piperidinium) cationic polymers having branched structures is used for the preparation of an anion exchange membrane or a catalyst layer binder.

Preferably, the preparation method of the anion exchange membrane includes: dissolving or dispersing the highly alkali-stable poly(arylene alkylene piperidinium) cationic polymers having branched structures in a third organic solvent to obtain a solution or a dispersion of the highly alkali-stable poly(arylene alkylene piperidinium) cationic polymers having branched structures, coating a substrate with the solution or the dispersion of the highly alkali-stable poly(arylene alkylene piperidinium) cationic polymers having branched structures, drying the substrate to remove the third organic solvent, and stripping and washing the substrate to obtain the anion exchange membrane.

Preferably, a coating method is one of the methods of solution casting membrane formation, spin coating, membrane scraping, tape casting and immersion membrane formation, and a solvent removal method is volatilization at a room temperature or heating and drying at 30° C. to 120° C.

Preferably, the third organic solvent is a polar aprotic solvent, and is specifically one or more of dimethyl sulfoxide, N-methylpyrrolidone, N,N-dimethylacetamide, or N,N-dimethylformamide.

Preferably, a preparation method of the catalyst layer binder includes: dissolving or dispersing the highly alkali-stable poly(arylene alkylene piperidinium) cationic polymers having branched structures in a fourth organic solvent to obtain a solution or a dispersion of the catalyst layer binder, and mixing the solution or the dispersion of the catalyst layer binder with a catalyst to obtain a slurry containing the highly alkali-stable poly(arylene alkylene piperidinium) cationic polymers having branched structures as the catalyst layer binder.

Preferably, the fourth organic solvent is a low-boiling-point organic solvent, and is more preferably one or more of methanol, ethanol, n-propanol, isopropanol, n-butanol, or water.

Preferably, the solution of the highly alkali-stable poly(arylene alkylene piperidinium) cationic polymers having branched structures has a concentration ranging from 1 wt % to 80 wt %, more preferably 1 wt % to 75 wt %, and further preferably 1 wt % to 40 wt %.

A mechanism of the present disclosure is as follows:

By adding multifunctional monomers to the polycondensation reaction catalyzed by a strong organic acid, a branched structure is formed in the cationic polymer. This significantly increases the molecular weight of the polymer and enhances the entanglement between polymer chains. As a result, the swelling resistance of the cationic polymer is greatly improved, ensuring the stable and safe operation of the device. Moreover, the piperidinium cation is connected to an aryl group by a flexible spacer, thereby reducing the influence of the aromatic ring on stability of the piperidinium group, and improving alkaline stability of the piperidinium groups.

Thus, the highly alkali-stable poly(arylene alkylene piperidinium) cationic polymers having branched structures is invented in the present disclosure, has the beneficial effects:

1. The preparation method of the highly alkali-stable cationic polymers having a branched structure according to the present disclosure is simple and facile, and is benefits to scaled production.

2. The highly alkali-stable cationic polymers having a branched structure prepared in the present disclosure has outstanding mechanical properties and swelling resistance under high ion exchange capacity, and exhibits excellent physical stability when being used for the preparation of anion exchange membrane or the binder of catalyst layer slurry.

3. According to the highly alkali-stable cationic polymers having a branched structure according to the present disclosure, the interaction force between the polymer molecular chains is enhanced and the polymer molecular weight is increased by means of a branching strategy. Moreover, the piperidinium cation is linked to a polymer skeleton having a branched structure by a flexible spacer, such that the prepared anion exchange membranes have outstanding alkali resistance.

4. The highly alkali-stable poly(arylene alkylene piperidinium) cationic polymers having branched structures prepared in the present disclosure can be used as a membrane material in many fields such as a fuel cell or a water electrolyzer. Moreover, the highly alkali-stable poly(arylene alkylene piperidinium) cationic polymers having branched structures can also be used as catalyst binder materials in a fuel cell or a water electrolyzer.

The technical solutions of the present disclosure will be further described in detail below by means of the accompanying drawings and the examples.

### BRIEF DESCRIPTION OF THE DRAWINGS

FIG. 1 is a graph showing that the temperature-dependent hydroxide conductivity of anion exchange membranes in Application Example 1 and Comparative Example 1 of the present disclosure.

FIG. 2 is a graph showing that the temperature-dependent water uptake of the anion exchange membranes in Application Example 1 and Comparative Example 1 of the present disclosure.

FIG. 3 is a graph showing that the temperature-dependent swelling ratio of the anion exchange membranes in Application Example 1 and Comparative Example 1 of the present disclosure.

FIG. 4 is a comparison of the mechanical properties of the anion exchange membranes in Application Example 1 and Comparative Example 1 of the present disclosure.

FIG. 5 is a graph of electrochemical properties of a catalyst layer binder and the anion exchange membrane prepared in Application Example 1 of the present disclosure.

### DETAILED DESCRIPTIONS OF THE EMBODIMENTS

The present disclosure will be further described below in combination with the accompanying drawings and the examples. Technical terms and scientific terms used in the present disclosure should have the general meanings as understood by those of ordinary skill in the art to which the present disclosure belongs unless otherwise defined. The above features mentioned in the present disclosure or the features mentioned in the particular examples can be freely combined, and these particular examples are only used to illustrate the present disclosure and not used to limit the scope of the present disclosure.

### Example 1

S1, 1,3,5-triphenylbenzene (0.01 g, 0.04 mmol), 1-piperidine-3-formaldehyde hydrochloride (0.19 g, 1.43 mmol) and p-terphenyl (0.30 g, 1.32 mmol) were mixed and then dispersed in dichloromethane (1.0 mL), and a polycondensation reaction was performed under the catalysis of a trifluoromethanesulfonic acid (2.0 mL) at 25° C. for 10 h to obtain a viscous dispersion of a polyaromatic polymer precursor containing piperidine moieties.

S2, the dispersion of the polyaromatic polymer precursor containing piperidine moieties obtained in S1 was added dropwise into a 1:1 (v/v) mixed solution of methanol and water slowly, and filtered after precipitation to obtain a white fibrous polymer, and the white fibrous polymer was filtered, washed completely, and dried in vacuum to obtain 0.45 g of polyaromatic polymer precursor containing piperidine moieties.

S3, the polyaromatic polymer precursor containing piperidine moieties obtained in S2 was dissolved in 10 mL of N-methylpyrrolidone, 0.50 mL of methyl iodide and 0.3 g of potassium carbonate were added, and the quaternization reaction was performed at a room temperature for 72 h to obtain a solution of highly alkali-stable poly(arylene alkylene piperidinium) cationic polymers having branched structures.

S4, the solution of the highly alkali-stable poly(arylene alkylene piperidinium) cationic polymers having branched structures obtained in S3 was slowly added into ether, and a precipitate was filtered and dried after precipitation to obtain 0.50 g of highly alkali-stable poly(arylene alkylene piperidinium) cationic polymer PTP-DMP-Tri-3% having a branched structure, where a structure was shown in (1):

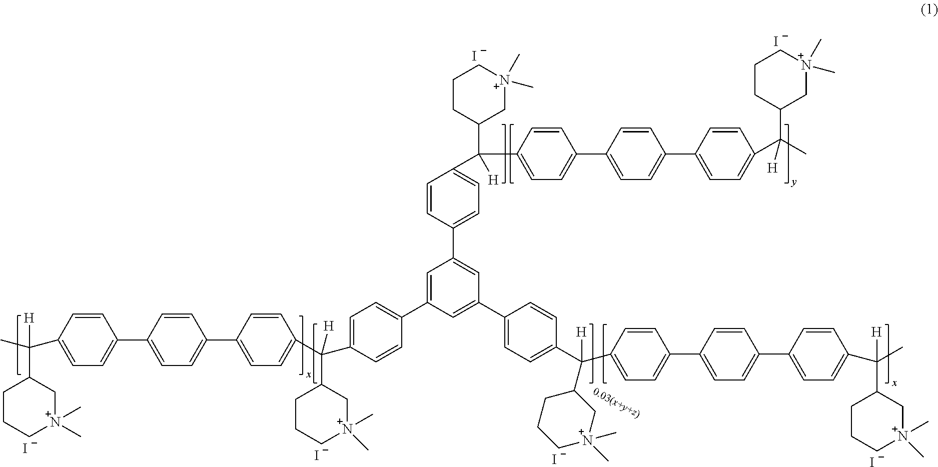

### Application Example 1

a. The Preparation of an Anion Exchange Membrane

The highly alkali-stable poly(arylene alkylene piperidinium) cationic polymer PTP-DMP-Tri-3% having a branched structure prepared in Example 1 was dissolved in 4 mL of dimethyl sulfoxide to obtain a solution of a highly alkali-stable poly(arylene alkylene piperidinium) cationic polymer having a branched structure, of which a mass fraction was about 10%. A clean glass plate was coated with the solution of the highly alkali-stable poly(arylene alkylene piperidinium) cationic polymers having branched structures by means of tape casting. The glass plate was placed in a thermoventilated oven at 80° C. for 24 h to remove the dimethyl sulfoxide. The glass plate was taken out after a temperature was reduced to room temperature, the glass plate was taken out and immersed in deionized water, and then completely washed with deionized water to obtain the first anion exchange membrane, in which the counter ion was I⁻.

b. Replacement of the Counter Ion in the Anion Exchange Membrane

The first anion exchange membrane, in which the counter ion was I⁻, was soaked in 1 mol/L NaOH solution for 48 h, and then completely washed with deionized water to obtain the first anion exchange membrane, in which a counter ion was OH⁻. The first anion exchange membrane, in which the counter ion was I⁻, was soaked in 2 mol/L NaCl solution for 24 h, and then completely washed with deionized water to obtain the first anion exchange membrane, in which the counter ion was Cl⁻.

c. Preparation of Catalyst Layer Binder

Ion exchange was performed on a counter ion in the PTP-DMP-Tri-3% prepared in Example 1 as required, and PTP-DMP-Tri-3% powder prepared in Example 1 was soaked in 2 mol/L NaOH solution for 48 h, then completely washed with deionized water, and filtered to obtain a highly alkali-stable poly(arylene alkylene piperidinium) cationic polymer having a branched structure, in which the counter ion was OH⁻.

The prepared highly alkali-stable poly(arylene alkylene piperidinium) cationic polymer having a branched structure, in which the counter ion was OH⁻, was dissolved in a mixed solvent of isopropanol and water at a solid content of 2 wt %, and a metal catalyst was added for mixing to prepare a slurry of a catalyst layer binder uniformly dispersed, i.e. slurry of a catalyst layer binder based on the highly alkali-stable poly(arylene alkylene piperidinium) cationic polymer having a branched structure, in which a counter ion was OH⁻.

### Comparative Example 1

S1, a polymerization mixture consisting of 1-piperidine-3-formaldehyde hydrochloride (0.19 g, 1.43 mmol) and p-terphenyl (0.3 g, 1.32 mmol) was placed in dichloromethane (1.0 mL), and a trifluoromethanesulfonic acid (1.0 mL) was added for catalytic polycondensation reaction at 25° C. for 10 h to obtain a viscous dispersion of a polymer having piperidine moieties.

S2, the dispersion of the polymer having piperidine moieties in S1 was added dropwise into a 1:1 (v/v) mixed solution of methanol and water slowly to obtain a pale yellow fibrous polymer, and the pale yellow fibrous polymer was filtered, washed completely, and dried in vacuum to obtain 0.43 g of white fibrous polymer powder having piperidine moieties.

S3, the polymer powder having piperidine moieties in S2 was dissolved in 5 mL of N-methylpyrrolidone, 0.50 mL of methyl iodide and 0.3 g of potassium carbonate were added, and a quaternization reaction was performed at a room temperature for 72 h to obtain a cationic polymer solution.

S4, the cationic polymer solution in S3 was slowly added into ether, filtered and dried to obtain 0.45 g of highly alkali-stable cationic polymer PTP-DMP powder, and an anion exchange membrane was prepared from the PTP-DMP powder, where the counter ion was I⁻. Moreover, the counter ion may be exchanged into OH⁻ or other counter ions (such as Cl⁻) as required, and a structure after replacement was shown as follows, a PTP-DMP membrane, in which a counter ion was OH⁻.

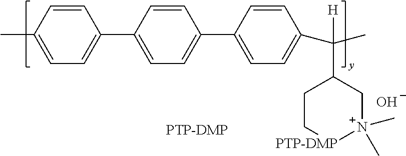

### Test Example 1

The following tests were performed on the first anion exchange membranes having different counter ions and the catalyst layer binder in Application Example 1 to characterize basic properties and then compared with the PTP-DMP membrane in Comparative Example 1.

a. Conductivity Test

Measurement was performed by means of an alternating current impedance method based on four electrodes. The first anion exchange membrane, in which the counter ion was OH⁻, and the anion exchange membrane PTP-DMP membrane were cut into 1 cm×5 cm sample strips, and then the sample strips were clamped on a clamp and then placed in a water tank containing pure water. The electrodes were installed and connected to an electrochemical workstation. Under a scanning frequency ranged from 1 MHz to 100 Hz in a constant current mode (0.1 mA), frequency ranges at which impedance was stable were found on Bode curves. Then the resistance R of the first anion exchange membrane and the anion exchange membrane PTP-DMP membrane was read on the corresponding curves.

Hydroxide ion conductivity was calculated by means of the following formula:

$$σ = \frac{L}{R \times w \times d}$$

R was the resistance of the anion exchange membrane, L was a distance between the electrodes (1.0 cm), W was a width of the anion exchange membrane, and d was a thickness of the anion exchange membrane.

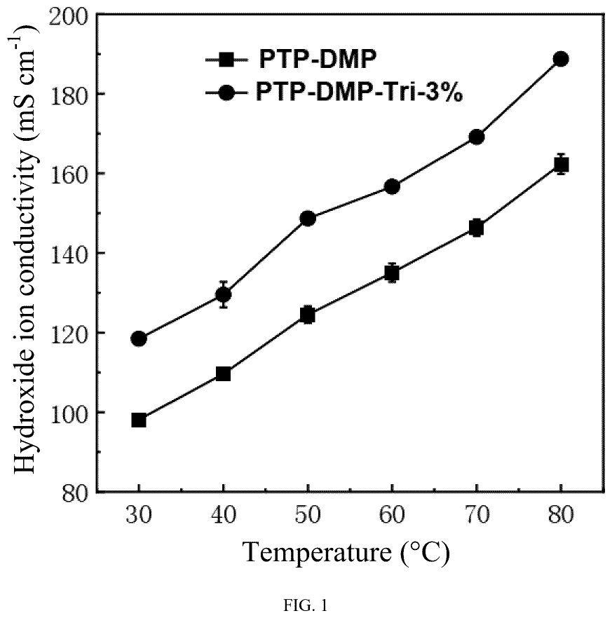

According to the hydroxide ion conductivity detected at different temperatures, a graph showing that the hydroxide ion conductivity of the anion exchange membrane varies with temperature was obtained, as shown in FIG. 1. FIG. 1 shows that at 80° C., the OH⁻ conductivity of the first anion exchange membrane having a branched structure, in which the counter ion was OH⁻, reached 188 mS·cm⁻¹, while the OH⁻ conductivity of the anion exchange membrane PTP-DMP membrane having no branched structure was only 162 mS·cm⁻¹.

b. Water Uptake (WU) and Swelling Ratio (SR)

The first anion exchange membrane and the anion exchange membrane PTP-DMP membrane were cut into 1 cm×8 cm sample strips respectively, the sample strips were dried completely in an oven, weight of a dried anion exchange membrane was recorded as W_{dry}, then the dried anion exchange membrane was soaked in deionized water, the anion exchange membrane was taken out every 12 h, wiping off the water on a surface of the anion exchange membrane, and weight W_{wet} of a soaked anion exchange membrane at different temperatures (30° C. to 80° C.) was recorded. The WU is calculated by means of the following formula:

$$WU = \frac{{W}_{wet} - {W}_{dry}}{{W}_{dry}} \times 100 \% .$$

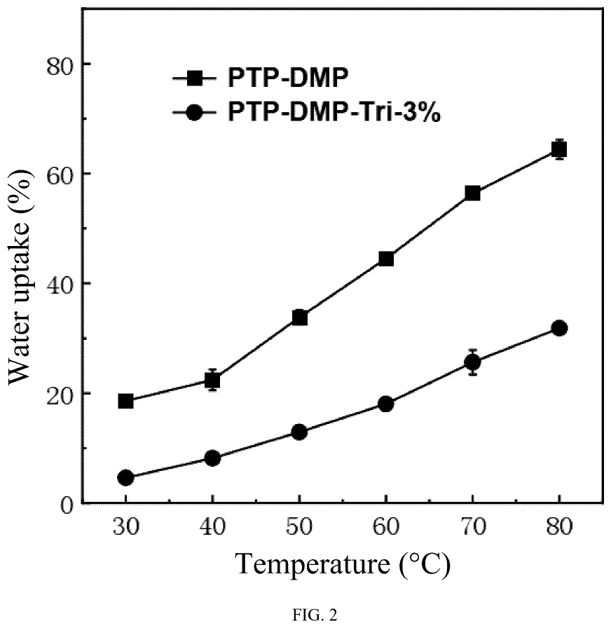

According to calculation of WUs measured at different temperatures, a graph showing that the WUs of the two anion exchange membranes vary with temperature was obtained, as shown in FIG. 2.

The SR was an important index for measuring stability of a membrane size, was obtained by calculating lengths (L_{dry} and L_{wet}) of the anion exchange membrane in a dry state and a wet state, and was calculated by means of the following formula:

$$SR = \frac{{L}_{wet} - {L}_{dry}}{{L}_{dry}} \times 100 \%$$

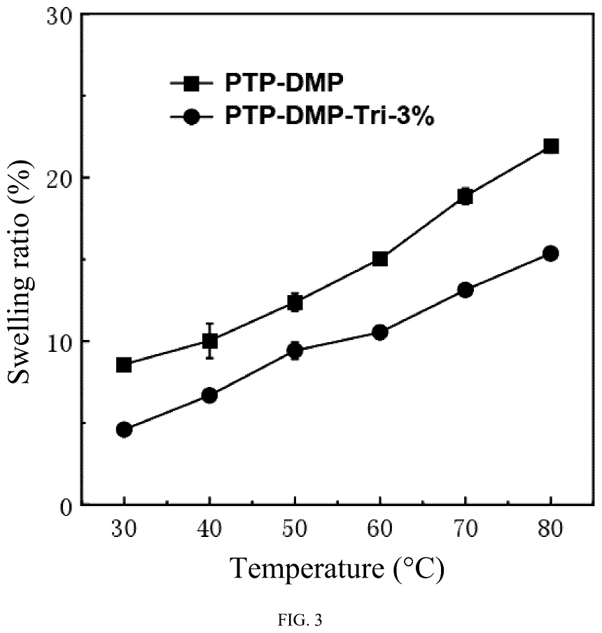

According to SRs measured at different temperatures, a graph showing that the SRs of the first anion exchange membrane, in which the counter ion was Cl⁻, and the PTP-DMP membrane, in which the counter ion was Cl⁻, was obtained, as shown in FIG. 3.

c. Mechanical Property Test

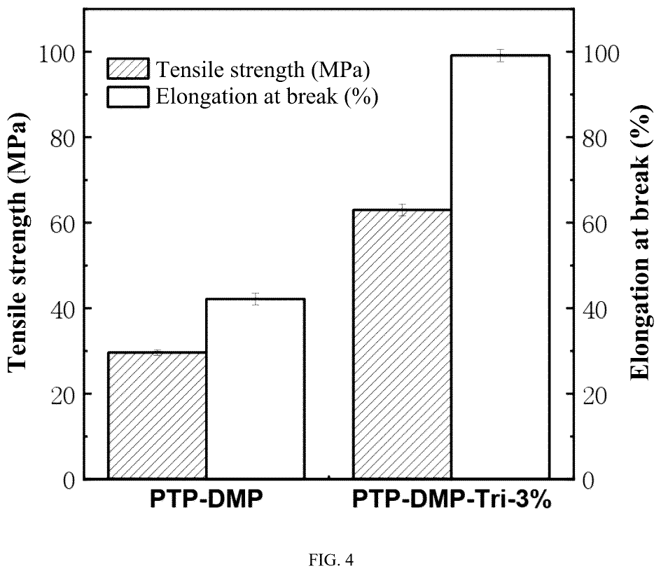

Tensile properties of the first anion exchange membrane and the anion exchange membrane PTP-DMP membrane were measured at a tensile speed of 5 mm min⁻¹ by means of a CMT 4506 electronic universal testing machine. The first anion exchange membrane and the anion exchange membrane PTP-DMP membrane were cut into dumbbell shapes of 40 mm×10 mm×0.03 mm (length×width×thickness), 3 parallel samples were set for each group of samples, and sample strips were balanced in a test environment for 24 h before using. A test result was shown in FIG. 4.

d. Electrochemical Property Test

A slurry of the catalyst layer binder and the first anion exchange membrane were prepared from the PTP-DMP-Tri-3% in Example 1 separately, Pt/C was used as a cathode catalyst and an anode catalyst, and a loading amount of Pt in an anode and a cathode was 0.5 mg cm⁻². Membrane electrodes were prepared by means of a catalyst coating technology.

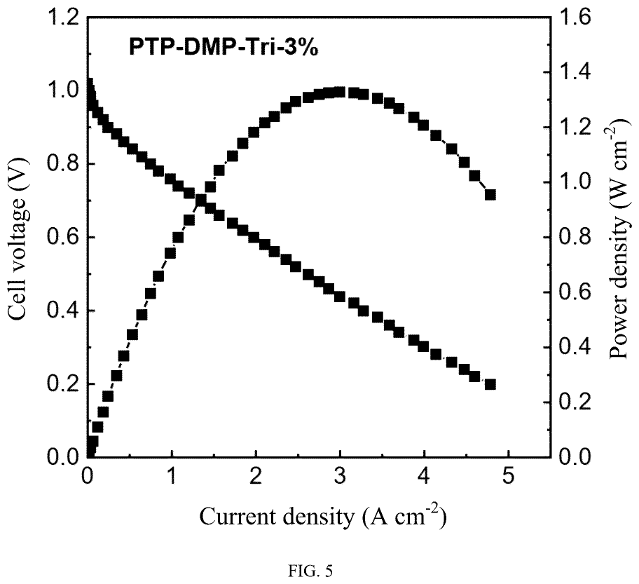

A H₂—O₂ fuel cell test was performed at 80° C., a gas flow rate was 300 mL min⁻¹, a back pressure was 150 kPa, and relative humidity (RH) was 100%. A graph of electrochemical properties of the slurry of the catalyst layer binder and the first anion exchange membrane prepared from the PTP-DMP-Tri-3% in Example 1 was obtained, as shown in FIG. 5.

To sum up, at 80° C., the hydroxide ion conductivity of the first anion exchange membrane reached 188 mS·cm⁻¹, the first anion exchange membrane had a low WU and SR and excellent mechanical properties, and a maximum power density of a membrane electrode formed from the PTP-DMP-Tri-3% reached 1.32 W·cm⁻².

### Example 2

S1, tetraphenylmethane (0.02 g, 0.08 mmol), 1-piperidine-3-formaldehyde hydrochloride (0.19 g, 1.43 mmol) and p-terphenyl (0.30 g, 1.32 mmol) were mixed, and then dispersed in dichloromethane (1.5 mL), and polycondensation reaction was performed under catalysis of a trifluoromethanesulfonic acid (2.2 mL) at 25° C. for 15 h to obtain a viscous dispersion of a polyaromatic polymer precursor containing piperidine moieties.

S2, the dispersion of the polyaromatic polymer precursor containing piperidine moieties obtained in S1 was added dropwise into a 1:1 (v/v) mixed solution of methanol and water slowly, and filtered after precipitation to obtain a pale yellow fibrous polymer, and the pale yellow fibrous polymer was filtered, washed completely, and then dried in vacuum to obtain 0.41 g of polyaromatic polymer precursor containing piperidine moieties.

S3, the polyaromatic polymer precursor containing piperidine moieties obtained in S2 was dissolved in 4 mL of N-methylpyrrolidone, 0.45 mL of methyl iodide and 0.2 g of potassium carbonate were added, and quaternization reaction was performed at a room temperature for 72 h to obtain a solution of highly alkali-stable poly(arylene alkylene piperidinium) cationic polymers having branched structures.

S4, the solution of the highly alkali-stable poly(arylene alkylene piperidinium) cationic polymers having branched structures obtained in S3 was slowly added into ether, and a precipitate was filtered and dried after precipitation to obtain 0.43 g of highly alkali-stable poly(arylene alkylene piperidinium) cationic polymers having branched structures, where the structure was shown as follows:

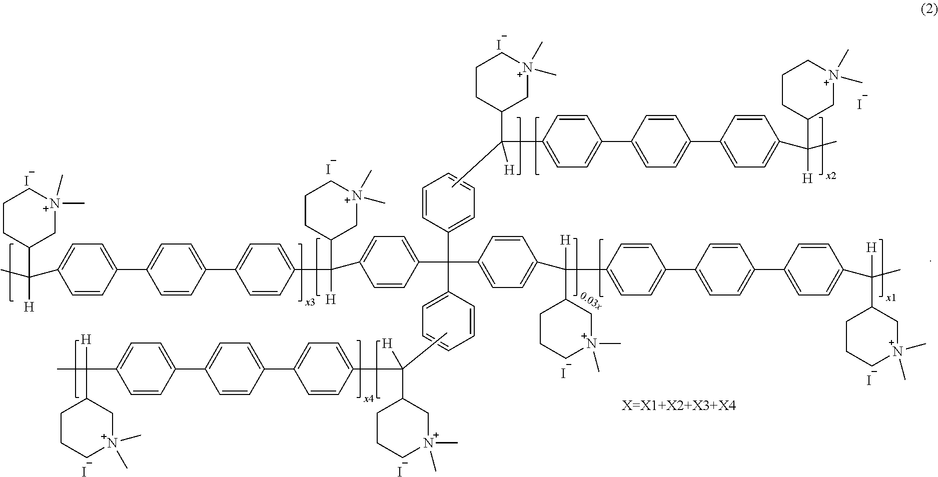

### Application Example 2

a. Preparation of the Anion Exchange Membrane

The highly alkali-stable poly(arylene alkylene piperidinium) cationic polymers having branched structures prepared in Example 2 was dissolved in 4 mL of dimethyl sulfoxide to obtain a solution of highly alkali-stable poly(arylene alkylene piperidinium) cationic polymers having branched structures, of which a mass fraction was about 10%. A clean glass plate was coated with the solution of the highly alkali-stable poly(arylene alkylene piperidinium) cationic polymers having branched structures by means of tape casting. The glass plate was dried in an air blast drying oven at 80° C. for 24 h to remove the solvent. The glass plate was taken out after a temperature was reduced to a room temperature, stripped in deionized water, and then completely washed with deionized water to obtain a second anion exchange membrane, in which a counter ion was I⁻.

b. Replacement of the Counter Ion in the Anion Exchange Membrane

Ion exchange was performed on an anion in the second anion exchange membrane, in which the counter ion was I⁻, prepared in a as required. The second anion exchange membrane, in which the counter ion was I⁻, was soaked in 2 mol/L NaCl solution for 24 h, and then completely washed with deionized water to obtain a second anion exchange membrane, in which a counter ion was Cl⁻.

c. Preparation of a Catalyst Layer Binder

Ion exchange was performed on a counter ion in the highly alkali-stable poly(arylene alkylene piperidinium) cationic polymers having branched structures prepared in Example 2 as required, and highly alkali-stable poly(arylene alkylene piperidinium) cationic polymer powder having a branched structure prepared in Example 2 was soaked in 2 mol/L NaOH solution for 48 h, then completely washed with deionized water, and filtered to obtain highly alkali-stable poly(arylene alkylene piperidinium) cationic polymers having branched structures, in which the counter ion was OH⁻.

The prepared highly alkali-stable poly(arylene alkylene piperidinium) cationic polymers having branched structures, in which a counter ion was OH⁻, was dissolved in a mixed solvent of isopropanol and water at a solid content of 2 wt %, and mixed with a metal catalyst to prepare a slurry uniformly dispersed, i.e. slurry of a catalyst layer binder based on the highly alkali-stable poly(arylene alkylene piperidinium) cationic polymers having branched structures in Example 2.

### Example 3

S1, 1,3,5-triphenylbenzene (0.04 g, 0.14 mmol), 1-piperidine-3-formaldehyde hydrochloride (0.38 g, 2.86 mmol) and biphenyl (0.20 g, 1.32 mmol) were mixed and dispersed in dichloromethane (4.0 mL), and polycondensation reaction was performed under catalysis of a trifluoromethanesulfonic acid (4.5 mL) at 25° C. for 24 h to obtain a viscous dispersion of a polyaromatic polymer precursor containing piperidine moieties.

S2, the dispersion of the polyaromatic polymer precursor containing piperidine moieties obtained in S1 was added dropwise into a 1:1 (v/v) mixed solution of methanol and water slowly, and filtered after precipitation to obtain a pale yellow fibrous polymer, and the pale yellow fibrous polymer was filtered, washed completely, and dried in vacuum to obtain 0.82 g of white fibrous polyaromatic polymer precursor containing piperidine moieties.

S3, the polyaromatic polymer precursor containing piperidine moieties obtained in S2 was dissolved in 6 mL of N-methylpyrrolidone, 0.90 mL of methyl iodide and 0.4 g of potassium carbonate were added, and quaternization reaction was performed at a room temperature for 72 h to obtain a solution of highly alkali-stable poly(arylene alkylene piperidinium) cationic polymers having branched structures.

S4, the solution of the highly alkali-stable poly(arylene alkylene piperidinium) cationic polymers having branched structures obtained in S3 was slowly added into ether, and a precipitate was filtered and dried after precipitation to obtain 0.87 g of highly alkali-stable poly(arylene alkylene piperidinium) cationic polymers having branched structures, where a structure was shown as follows:

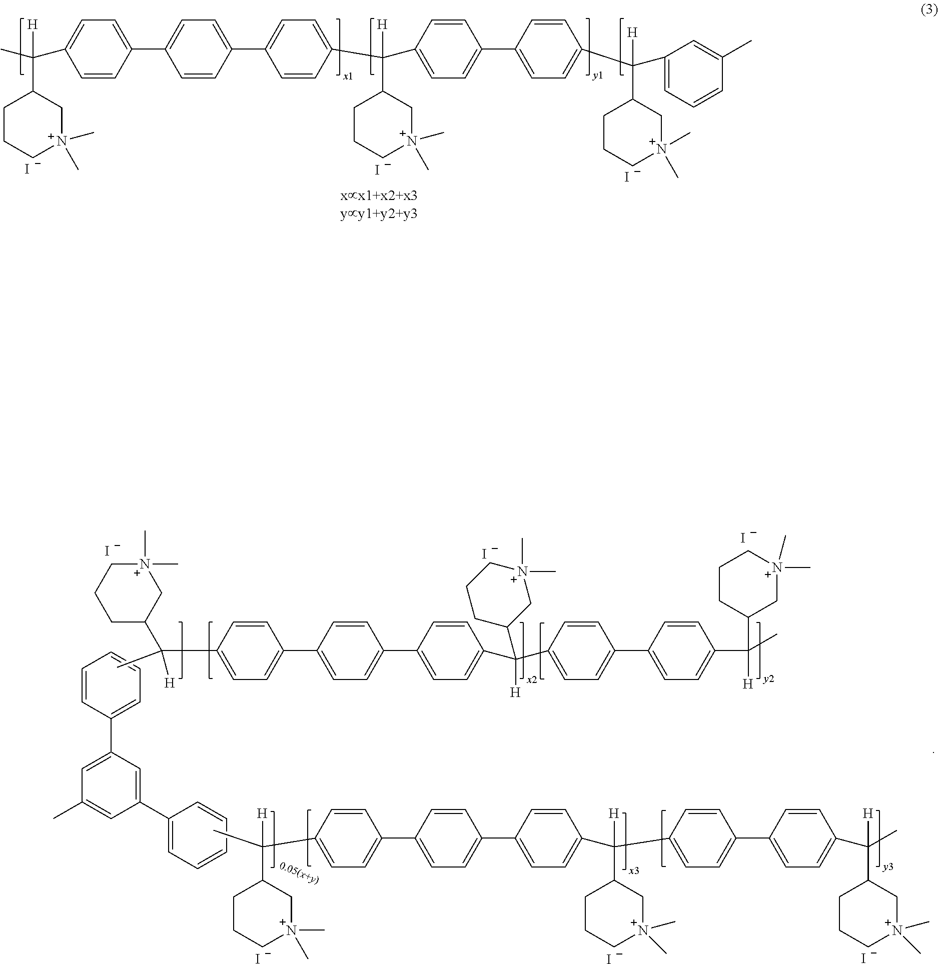

### Application Example 3

The highly alkali-stable cationic polymers having a branched structure prepared in Example 3 was dissolved in 7 mL of dimethyl sulfoxide to obtain a solution of highly alkali-stable poly(arylene alkylene piperidinium) cationic polymers having branched structures, of which a mass fraction was about 10%. A clean glass plate was coated with the solution of the highly alkali-stable poly(arylene alkylene piperidinium) cationic polymers having branched structures by means of tape casting. The glass plate was dried in an air blast drying oven at 80° C. for 24 h to remove the solvent. The glass plate was taken out after a temperature was reduced to a room temperature, stripped in deionized water, and then completely washed with deionized water to obtain a third anion exchange membrane, in which the counter ion was I⁻.

b. Replacement of the Counter Ion in the Anion Exchange Membrane

Ion exchange was performed on an anion in the third anion exchange membrane, in which the counter ion was I⁻, prepared in a as required. The third anion exchange membrane, in which the counter ion was I⁻, was soaked in 2 mol/L NaCl solution for 24 h, and then completely washed with deionized water to obtain a third anion exchange membrane, in which a counter ion was Cl⁻.

c. Preparation of a Catalyst Layer Binder

Ion exchange was performed on a counter ion in the highly alkali-stable poly(arylene alkylene piperidinium) cationic polymers having branched structures prepared in Example 3 as required, and highly alkali-stable poly(arylene alkylene piperidinium) cationic polymers powder having a branched structure prepared in Example 3 was soaked in 2 mol/L NaOH solution for 48 h, then completely washed with deionized water, and filtered to obtain highly alkali-stable poly(arylene alkylene piperidinium) cationic polymers having branched structures, in which a counter ion was OH⁻.

The prepared highly alkali-stable poly(arylene alkylene piperidinium) cationic polymers having branched structures, in which a counter ion was OH⁻, was dissolved in a mixed solvent of isopropanol and water at a solid content of 2 wt %, and mixed with a metal catalyst to prepare a slurry uniformly dispersed, i.e. slurry of a catalyst layer binder based on the highly alkali-stable poly(arylene alkylene piperidinium) cationic polymers having branched structures in Example 3.

### Example 4

S1, 1,3,5-triphenylbenzene (0.03 g, 0.12 mmol), spirofluorene (0.03 g, 0.12 mmol), 1-piperidine-3-formaldehyde hydrochloride (0.39 g, 2.30 mmol) and biphenyl (0.40 g, 2.60 mmol) were mixed and dispersed in dichloromethane (3.0 mL), and polycondensation reaction was performed under catalysis of a trifluoromethanesulfonic acid (2.5 mL) at 25° C. for 48 h to obtain a viscous dispersion of a polyaromatic polymer precursor containing piperidine moieties.

S2, the dispersion of the polyaromatic polymer precursor containing piperidine moieties obtained in S1 was added dropwise into a 1:1 (v/v) mixed solution of methanol and water slowly, and filtered after precipitation to obtain a pale yellow fibrous polymer, and the pale yellow fibrous polymer was filtered, washed completely, and dried in vacuum to obtain 0.78 g of white fibrous polyaromatic polymer precursor containing piperidine moieties.

S3, the polyaromatic polymer precursor containing piperidine moieties obtained in S2 was dissolved in 6 mL of N-methylpyrrolidone, 1.32 mL of methyl iodide and 0.9 g of potassium carbonate were added, and quaternization reaction was performed at a room temperature for 72 h to obtain a solution of highly alkali-stable poly(arylene alkylene piperidinium) cationic polymers having branched structures.

S4, the solution of the highly alkali-stable poly(arylene alkylene piperidinium) cationic polymers having branched structures obtained in S3 was slowly added into ether, and a precipitate was filtered and dried after precipitation to obtain 0.85 g of highly alkali-stable poly(arylene alkylene piperidinium) cationic polymers having branched structures, where a structure was as shown in (4):

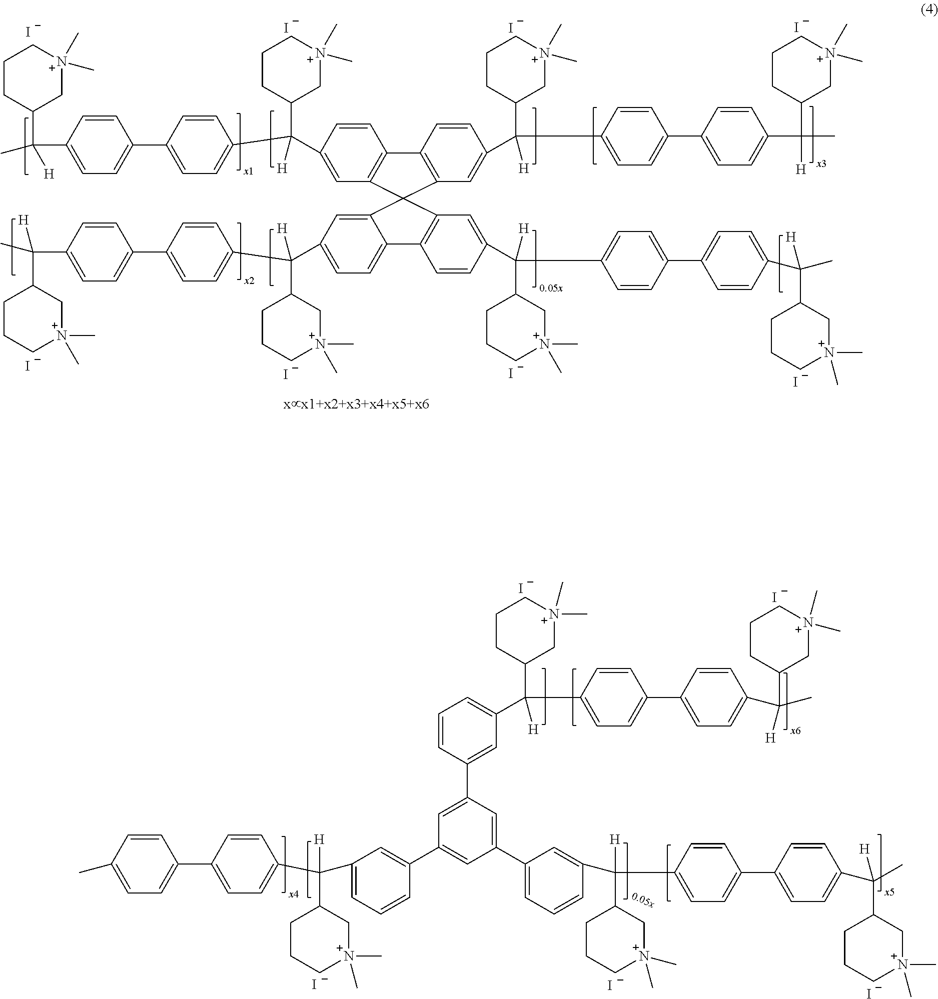

### Application Example 4

a. Preparation of the Anion Exchange Membrane

The highly alkali-stable poly(arylene alkylene piperidinium) cationic polymers having branched structures prepared in Example 4 was dissolved in 9 mL of dimethyl sulfoxide to obtain a solution of highly alkali-stable poly(arylene alkylene piperidinium) cationic polymers solution having a branched structure, of which a mass fraction was about 10%. A clean glass plate was coated with the solution of the highly alkali-stable poly(arylene alkylene piperidinium) cationic polymers having branched structures by means of tape casting. The glass plate was dried in an air blast drying oven at 80° C. for 24 h to remove the solvent. The glass plate was taken out after a temperature was reduced to a room temperature, stripped in deionized water, and then completely washed with deionized water to obtain a fourth anion exchange membrane, in which the counter ion was I⁻.

b. Replacement of the Counter Ion in the Anion Exchange Membrane

Ion exchange was performed on an anion in the fourth anion exchange membrane, in which the counter ion was I⁻, prepared in a as required. The fourth anion exchange membrane, in which the counter ion was I⁻, was soaked in 2 mol/L NaCl solution for 24 h, and then completely washed with deionized water to obtain a fourth anion exchange membrane, in which a counter ion was Cl⁻.

c. Preparation of a Catalyst Layer Binder

Ion exchange was performed on a counter ion in the highly alkali-stable poly(arylene alkylene piperidinium) cationic polymers having branched structures prepared in Example 4 as required, and highly alkali-stable poly(arylene alkylene piperidinium) cationic polymers powder having a branched structure prepared in Example 4 was soaked in 2 mol/L NaOH solution for 48 h, then completely washed with deionized water, and filtered to obtain a cationic polymer, in which the counter ion was OH⁻.

The prepared cationic polymer, in which a counter ion was OH⁻, was dissolved in a mixed solvent of isopropanol and water at a solid content of 2 wt %, and mixed with a metal catalyst to prepare a slurry uniformly dispersed, which is the slurry of a catalyst layer binder based on the cationic polymer in Example 4.

### Example 5

S1, triphenylmethane (0.02 g, 0.08 mmol), 1-piperidine-3-formaldehyde hydrochloride (0.10 g, 0.72 mmol), 1-piperidine-3-one hydrochloride (0.09 g, 0.72 mmol) and p-terphenyl (0.30 g, 1.32 mmol) were mixed and dispersed in dichloromethane (1.5 mL), and polycondensation reaction was performed under catalysis of a trifluoromethanesulfonic acid (2.5 mL) at 25° C. for 48 h to obtain a viscous dispersion of a polyaromatic polymer precursor containing piperidine moieties.

S2, the dispersion of the polyaromatic polymer precursor containing piperidine moieties obtained in S1 was added dropwise into a 1:1 (v/v) mixed solution of methanol and water slowly, and filtered after precipitation to obtain a pale yellow fibrous polymer, and the pale yellow fibrous polymer was filtered, washed completely, and dried in vacuum to obtain 0.46 g of white fibrous polyaromatic polymer precursor containing piperidine moieties.

S3, the polyaromatic polymer precursor containing piperidine moieties obtained in S2 was dissolved in 6 mL of N-methylpyrrolidone, 0.40 mL of methyl iodide and 0.3 g of potassium carbonate were added, and quaternization reaction was performed at a room temperature for 72 h to obtain a solution of highly alkali-stable poly(arylene alkylene piperidinium) cationic polymers having branched structures.

S4, The solution of the highly alkali-stable poly(arylene alkylene piperidinium) cationic polymers having branched structures obtained in S3 was slowly added into ether, and a precipitate was filtered and dried after precipitation to obtain 0.50 g of highly alkali-stable poly(arylene alkylene piperidinium) cationic polymers having branched structures, where the structure was shown in (5):

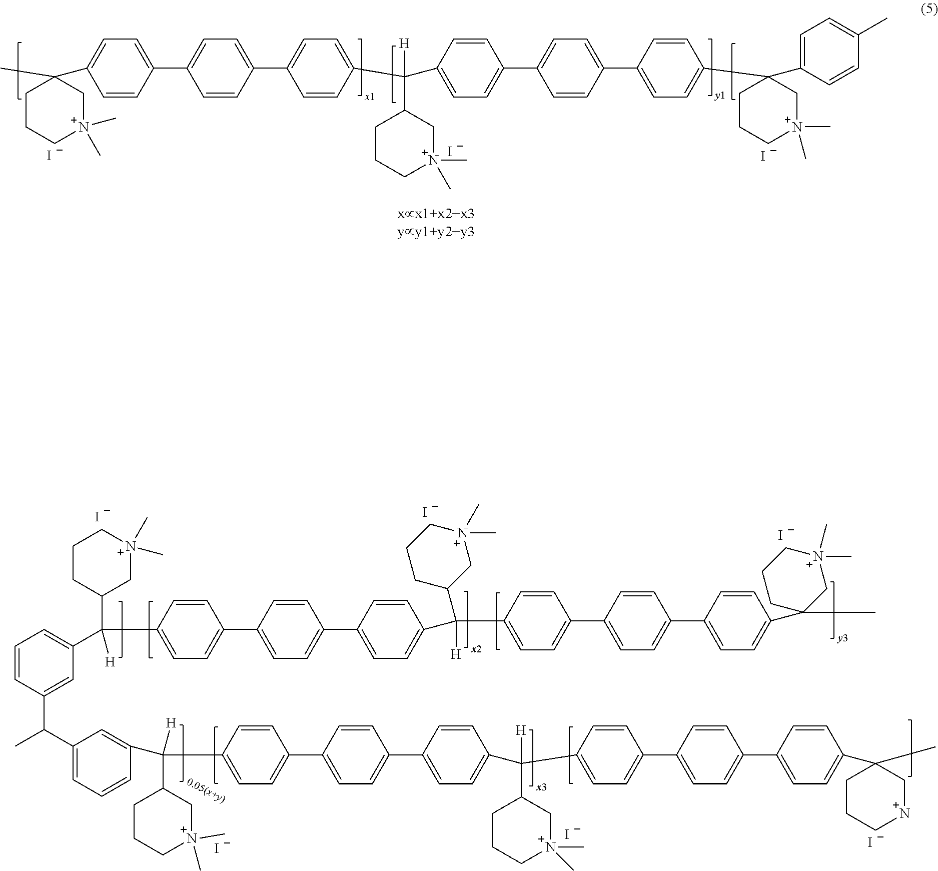

### Application Example 5

a. Preparation of the Anion Exchange Membrane

The highly alkali-stable cationic polymers having a branched structure prepared in Example 5 was dissolved in 5 mL of dimethyl sulfoxide to obtain a solution of highly alkali-stable poly(arylene alkylene piperidinium) cationic polymers having branched structures, of which a mass fraction was about 10%. A clean glass plate was coated with the solution of the highly alkali-stable poly(arylene alkylene piperidinium) cationic polymers having branched structures by means of tape casting. The glass plate was dried in an air blast drying oven at 80° C. for 24 h to remove the solvent. The glass plate was taken out after a temperature was reduced to a room temperature, stripped in deionized water, and then completely washed with deionized water to obtain a fifth anion exchange membrane, in which the counter ion was I⁻.

b. Replacement of the Counter Ion in the Anion Exchange Membrane

Ion exchange was performed on an anion in the fifth anion exchange membrane, in which the counter ion was I⁻, prepared in a as required. The fifth anion exchange membrane, in which the counter ion was I⁻, was soaked in 2 mol/L NaCl solution for 24 h, and then completely washed with deionized water to obtain a fifth anion exchange membrane, in which the counter ion was Cl⁻.

c. Preparation of a Catalyst Layer Binder

Ion exchange was performed on a counter ion in the highly alkali-stable poly(arylene alkylene piperidinium) cationic polymers having branched structures prepared in Example 5 as required, and highly alkali-stable poly(arylene alkylene piperidinium) cationic polymers powder having a branched structure prepared in Example 5 was soaked in 2 mol/L NaOH solution for 48 h, then completely washed with deionized water, and filtered to obtain highly alkali-stable poly(arylene alkylene piperidinium) cationic polymers having branched structures, in which a counter ion was OH⁻.

The prepared highly alkali-stable poly(arylene alkylene piperidinium) cationic polymers having branched structures, in which a counter ion was OH⁻, was dissolved in a mixed solvent of isopropanol and water at a solid content of 2 wt %, and mixed with a metal catalyst to prepare a slurry uniformly dispersed, i.e. slurry of a catalyst layer binder based on the highly alkali-stable poly(arylene alkylene piperidinium) cationic polymers having branched structures in Example 5.

### Example 6

S1, triptycene (0.02 g, 0.08 mmol), 1-piperidine-3-formaldehyde hydrochloride (0.10 g, 0.72 mmol), 7-bromo-1,1,1-trifluoro-2-heptanone (0.18 g, 0.72 mmol) and fluorene (0.30 g, 1.32 mmol) were mixed and dispersed in dichloromethane (2.0 mL), and polycondensation reaction was performed under catalysis of a trifluoromethanesulfonic acid (2.0 mL) at 25° C. for 4 h to obtain a viscous dispersion of a polyaromatic polymer precursor containing piperidine moieties.

S2, the dispersion of the polyaromatic polymer precursor containing piperidine moieties obtained in S1 was added dropwise into a 1:1 (v/v) mixed solution of methanol and water slowly, and filtered after precipitation to obtain a pale yellow fibrous polymer, and the pale yellow fibrous polymer was filtered, washed completely, and dried in vacuum to obtain 0.55 g of white fibrous polyaromatic polymer precursor containing piperidine moieties.

S3, the polyaromatic polymer precursor containing piperidine moieties obtained in S2 was dissolved in 6 mL of N-methylpyrrolidone, 0.20 mL of methyl iodide, 2.4 mL of trimethylamine solution (4.2 mol L 1 ethanol solution) and 0.2 g of potassium carbonate were added, and quaternization reaction was performed at a room temperature for 72 h to obtain a solution of highly alkali-stable poly(arylene alkylene piperidinium) cationic polymers having branched structures.

S4, the solution of the highly alkali-stable poly(arylene alkylene piperidinium) cationic polymers having branched structures obtained in S3 was slowly added into ether, and a precipitate was filtered and dried after precipitation to obtain 0.62 g of highly alkali-stable poly(arylene alkylene piperidinium) cationic polymers having branched structures, where the structure was shown in (6):

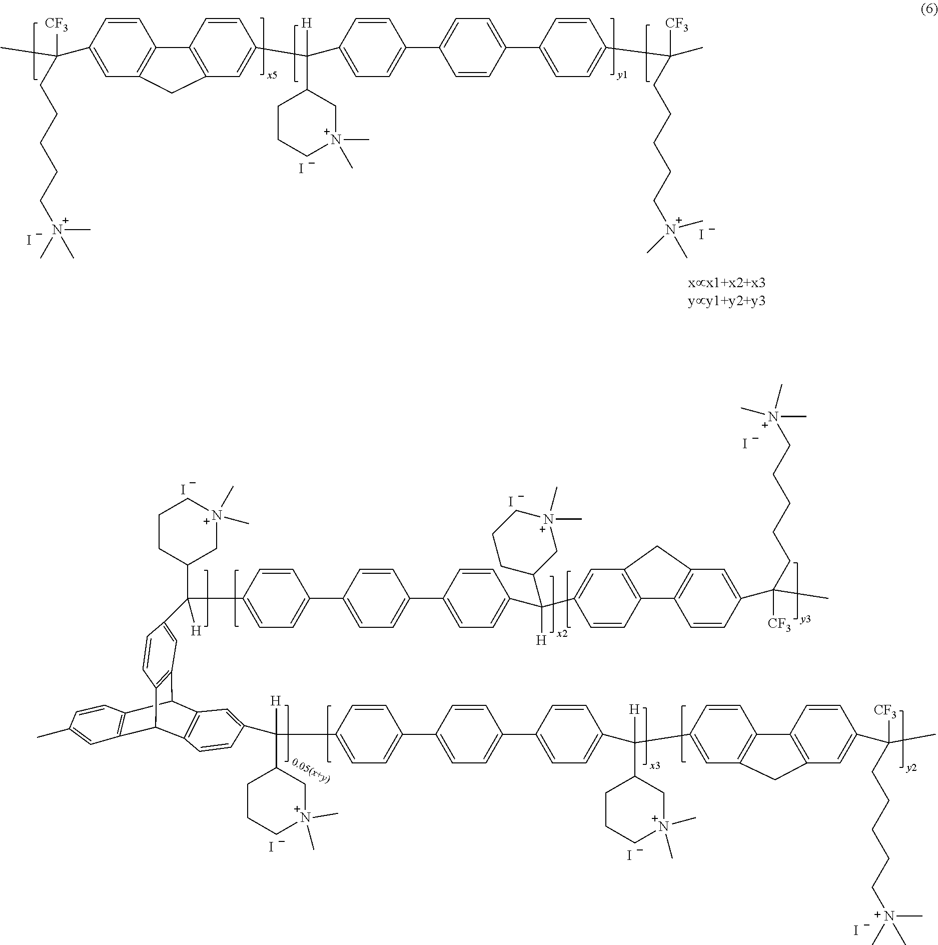

### Application Example 6

a. Preparation of the Anion Exchange Membrane

The highly alkali-stable cationic polymers having a branched structure prepared in Example 6 was dissolved in 6 mL of dimethyl sulfoxide to obtain a solution of highly alkali-stable poly(arylene alkylene piperidinium) cationic polymers having branched structures, of which a mass fraction was about 10%. A clean glass plate was coated with the solution of the highly alkali-stable poly(arylene alkylene piperidinium) cationic polymers having branched structures by means of tape casting. The glass plate was dried in an air blast drying oven at 80° C. for 24 h to remove the solvent. The glass plate was taken out after a temperature was reduced to a room temperature, stripped in deionized water, and then completely washed with deionized water to obtain a sixth anion exchange membrane, in which the counter ion was I⁻.

b. Replacement of the Counter Ion in the Anion Exchange Membrane

Ion exchange was performed on an anion in the sixth anion exchange membrane, in which the counter ion was I⁻, prepared in a as required. The sixth anion exchange membrane, in which the counter ion was I⁻, was soaked in 2 mol/L NaCl solution for 24 h, and then completely washed with deionized water to obtain a sixth anion exchange membrane, in which the counter ion was Cl⁻.

c. Preparation of a Catalyst Layer Binder

Ion exchange was performed on a counter ion in the highly alkali-stable poly(arylene alkylene piperidinium) cationic polymers having branched structures prepared in Example 6 as required, and highly alkali-stable poly(arylene alkylene piperidinium) cationic polymer powder having a branched structure prepared in Example 6 was soaked in 2 mol/L NaOH solution for 48 h, then completely washed with deionized water, and filtered to obtain highly alkali-stable poly(arylene alkylene piperidinium) cationic polymers having branched structures, in which the counter ion was OH⁻.

The prepared highly alkali-stable poly(arylene alkylene piperidinium) cationic polymers having branched structures, in which a counter ion was OH⁻, was dissolved in a mixed solvent of isopropanol and water at a solid content of 2 wt %, and mixed with a metal catalyst to prepare a slurry uniformly dispersed, i.e. slurry of a catalyst layer binder based on the highly alkali-stable poly(arylene alkylene piperidinium) cationic polymers having branched structures in Example 6.

### Example 7

S1, spirofluorene (0.02 g, 0.08 mmol), 1-piperidine-3-formaldehyde hydrochloride (0.19 g, 1.43 mmol), and spiro (cyclohexane-1,9′-fluorene) (0.32 g, 1.29 mmol) were mixed and dispersed in dichloromethane (1.2 mL), and polycondensation reaction was performed under catalysis of a trifluoromethanesulfonic acid (1.2 mL) at 25° C. for 48 h to obtain a viscous dispersion of a polyaromatic polymer precursor containing piperidine moieties.

S2, the dispersion of the polyaromatic polymer precursor containing piperidine moieties obtained in S1 was added dropwise into a 1:1 (v/v) mixed solution of methanol and water slowly, and filtered after precipitation to obtain a pale yellow fibrous polymer, and the pale yellow fibrous polymer was filtered, washed completely, and then dried in vacuum to obtain 0.41 g of white fibrous polyaromatic polymer precursor containing piperidine moieties.

S3, the polyaromatic polymer precursor containing piperidine moieties obtained in S2 was dissolved in 4 mL of N-methylpyrrolidone, 0.70 mL of methyl iodide and 0.5 g of potassium carbonate were added, and quaternization reaction was performed at a room temperature for 72 h to obtain a solution of highly alkali-stable poly(arylene alkylene piperidinium) cationic polymers having branched structures.

S4, the solution of the highly alkali-stable poly(arylene alkylene piperidinium) cationic polymers having branched structures obtained in S3 was slowly added into ether, and a precipitate was filtered and dried after precipitation to obtain 0.47 g of highly alkali-stable poly(arylene alkylene piperidinium) cationic polymers having branched structures, where the structure was shown in (7):

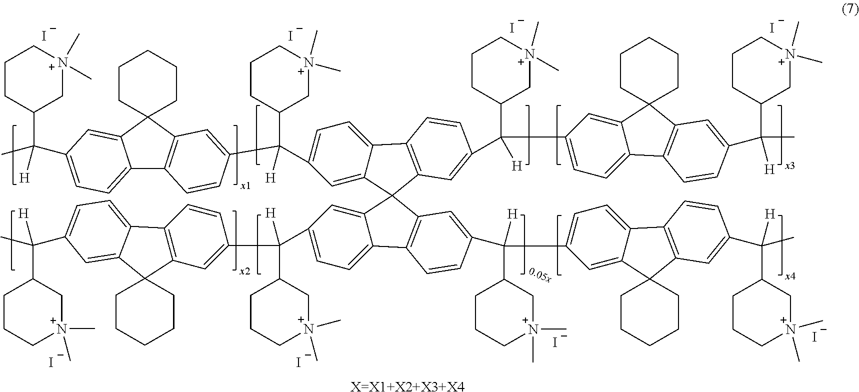

### Application Example 7

### Preparation of a Catalyst Layer Binder

Ion exchange was performed on a counter ion in the highly alkali-stable poly(arylene alkylene piperidinium) cationic polymers having branched structures prepared in Example 7 as required, and highly alkali-stable poly(arylene alkylene piperidinium) cationic polymer powder having a branched structure prepared in Example 7 was soaked in 2 mol/L NaOH solution for 48 h, then completely washed with deionized water, and filtered to obtain a cationic polymer, in which the counter ion was OH⁻.

The prepared cationic polymer, in which the counter ion was OH⁻, was dissolved in a mixed solvent of isopropanol and water at a solid content of 2 wt %, and mixed with a metal catalyst to prepare a slurry uniformly dispersed, i.e. slurry of a catalyst layer binder based on the highly alkali-stable poly(arylene alkylene piperidinium) cationic polymers having branched structures in Example 7.

### Example 8

S1, phenanthrene (0.02 g, 0.08 mmol), 1-piperidine-3-formaldehyde hydrochloride (0.19 g, 1.43 mmol), and 9,9-dimethylfluorene (0.32 g, 1.29 mmol) were mixed and dispersed in dichloromethane (1.2 mL), and polycondensation reaction was performed under catalysis of a trifluoromethanesulfonic acid (1.2 mL) at 25° C. for 48 h to obtain a viscous dispersion of a polyaromatic polymer precursor containing piperidine moieties.

S2, the dispersion of the polyaromatic polymer precursor containing piperidine moieties obtained in S1 was added dropwise into a 1:1 (v/v) mixed solution of methanol and water slowly, and filtered after precipitation to obtain a pale yellow fibrous polymer, and the pale yellow fibrous polymer was filtered, washed completely, and then dried in vacuum to obtain 0.41 g of white fibrous polyaromatic polymer precursor containing piperidine moieties.

S3, the polyaromatic polymer precursor containing piperidine moieties obtained in S2 was dissolved in 4 mL of N-methylpyrrolidone, 3.0 mL of 1,5-diiodopentane and 0.5 g of potassium carbonate were added, and quaternization reaction was performed at a room temperature for 72 h to obtain a solution of highly alkali-stable poly(arylene alkylene piperidinium) cationic polymers having branched structures.

S4, the solution of the highly alkali-stable poly(arylene alkylene piperidinium) cationic polymers having branched structures obtained in S3 was slowly added into ether, and a precipitate was filtered and dried after precipitation to obtain 0.55 g of highly alkali-stable poly(arylene alkylene piperidinium) cationic polymers having branched structures, where the structure was shown in (8):

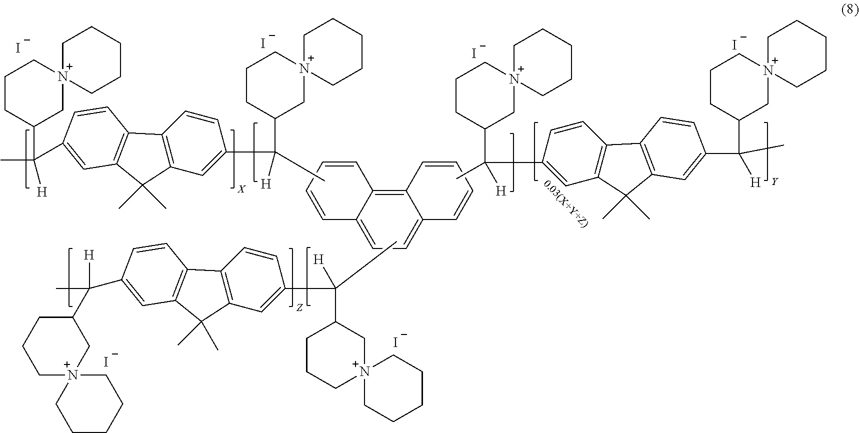

### Application Example 8

### Preparation of a Catalyst Layer Binder

Ion exchange was performed on a counter ion in the highly alkali-stable poly(arylene alkylene piperidinium) cationic polymers having branched structures prepared in Example 8 as required, and highly alkali-stable poly(arylene alkylene piperidinium) cationic polymer powder having a branched structure prepared in Example 8 was soaked in 2 mol/L NaOH solution for 48 h, then completely washed with deionized water, and filtered to obtain a cationic polymer, in which the counter ion was OH⁻.

The prepared cationic polymer, in which a counter ion was OH⁻, was dissolved in a mixed solvent of isopropanol and water at a solid content of 2 wt %, and mixed with a metal catalyst to prepare a slurry uniformly dispersed, i.e. slurry of a catalyst layer binder based on the highly alkali-stable poly(arylene alkylene piperidinium) cationic polymers having branched structures in Example 8.

Thus, the highly alkali-stable poly(arylene alkylene piperidinium) cationic polymers having branched structures of the above is used in the present disclosure, and can be used as a membrane material in a number of fields such as a fuel cell and electrolyzed water. Moreover, the highly alkali-stable poly(arylene alkylene piperidinium) cationic polymers having branched structures can be used as a catalyst binder material in the fuel cell and an electrolyzed water catalyst layer.

Finally, it should be noted that the above examples are merely used for describing the technical solutions of the present disclosure rather than limiting the present disclosure. Although the present disclosure has been described in detail with reference to the preferred examples, those of ordinary skill in the art should understand that they can still make modifications or equivalent substitutions to the technical solutions of the present disclosure. These modifications or equivalent substitutions cannot enable the modified technical solutions to deviate from the spirit and scope of the technical solutions of the present disclosure.

What is claimed is:

1. Alkali-stable poly(arylene alkylene piperidinium) cationic polymers having branched structures, comprising: one or more of a central unit, a linear unit L₁, and a linear unit L₂;
wherein the central unit comprises one or more of an MA unit, a piperidinium group (m-DMP), or and CA unit;
wherein the linear unit L₁ comprises a piperidinium group (m-DMP) and a BA unit; and
wherein the linear unit L₂ comprises a BA unit and a CA unit;
wherein the piperidinium group (m-DMP) has a structural formula of 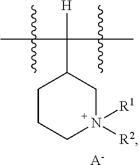
wherein R¹ and R² are independently selected from hydrocarbyl groups having 1-20 carbon atoms, or wherein R¹ and R² are connected to each other to form a cycloalkyl group consisting of 4 to 7 carbon atoms, and wherein the counter ion A′ is selected from one or more of halide ions, a methyl sulfate ion, a hydroxide ion, or a bicarbonate ion;
wherein the MA unit comprises 2 to 6 aromatic rings, and is independently selected from one or more of the following structures: 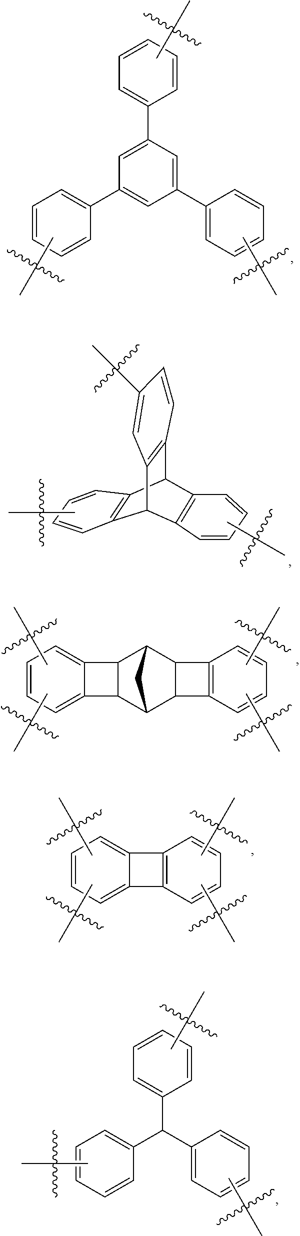 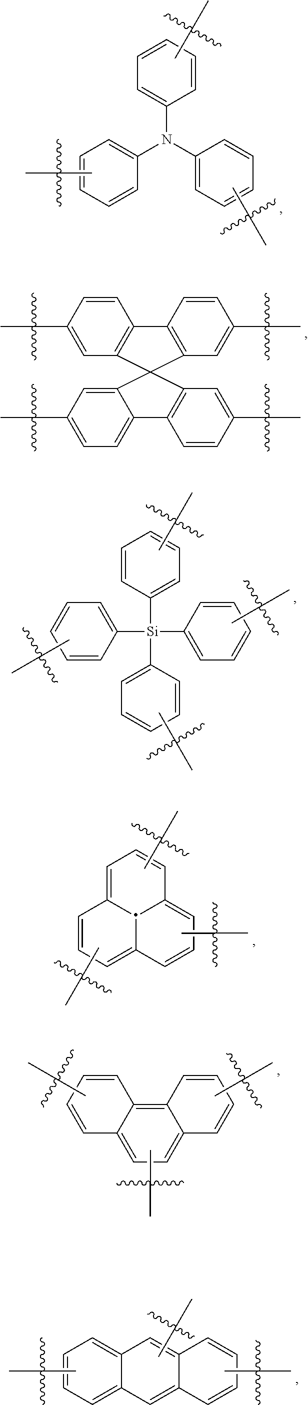 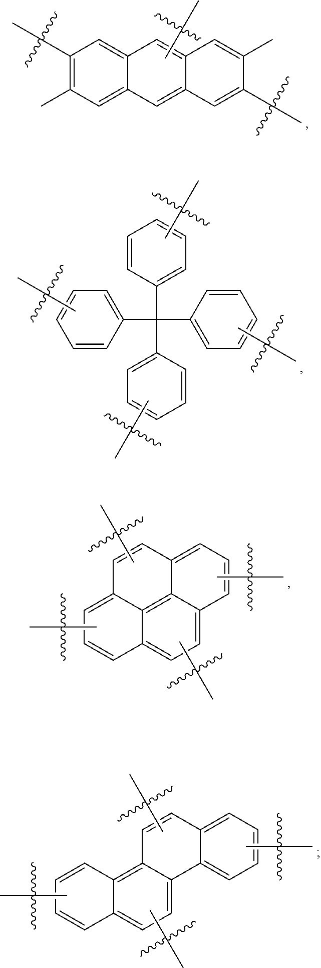
wherein the BA unit is independently selected from one or more of the following structures: 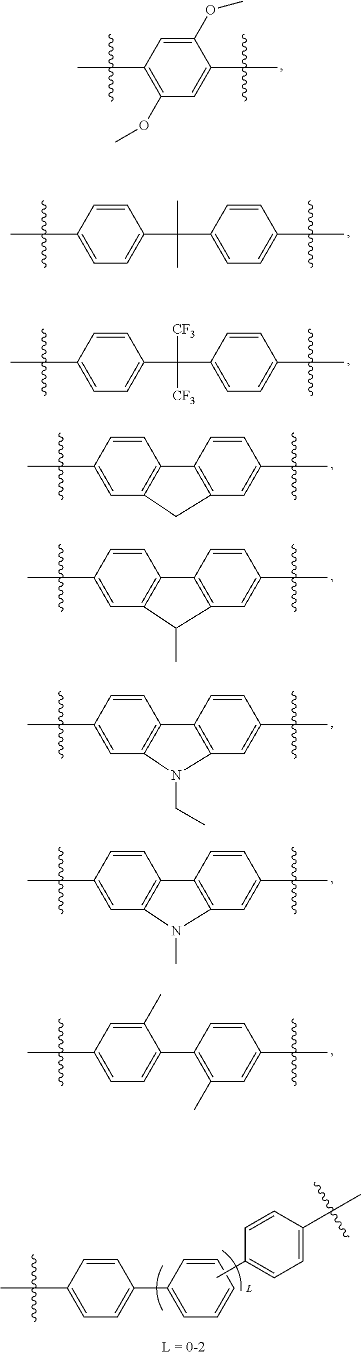 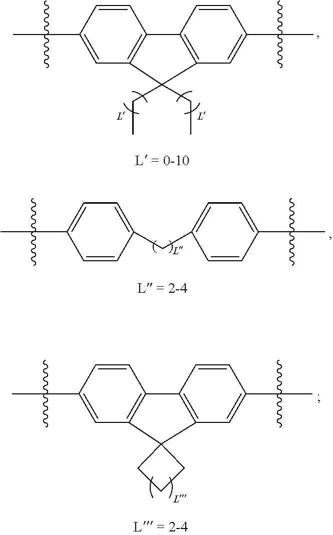
and wherein the CA unit comprises one or more of 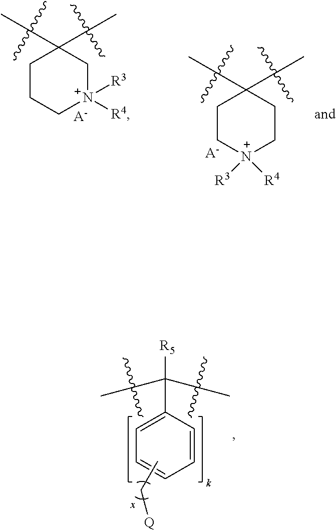
wherein R³ and R⁴ are independently selected from hydrocarbyl groups having 1-20 carbon atoms, or wherein R³ and R⁴ are connected to each other to form a cycloalkyl group consisting of 4 to 7 carbon atoms;
wherein each R⁵ is independently selected from a hydrogen atom, a hydrocarbyl group having 1-20 carbon atoms, or a fully or partially fluorinated alkyl group having 1-6 carbon atoms;
wherein k=0 or 1; x=0 to 12;
wherein Q is selected from one or more of a hydrogen atom, —N⁺(R⁶)₃, or nitrogen-containing heterocyclic cations;
wherein each R⁶ is independently selected from a hydrocarbyl group having 1-20 carbon atoms in —N⁺(R⁶)₃; and
wherein the nitrogen-containing heterocyclic cation comprises one or more of partially or fully substituted pyrazolium, pyrrolidinium, piperidinium, imidazolium, or quinuclidinium groups with the following structures: 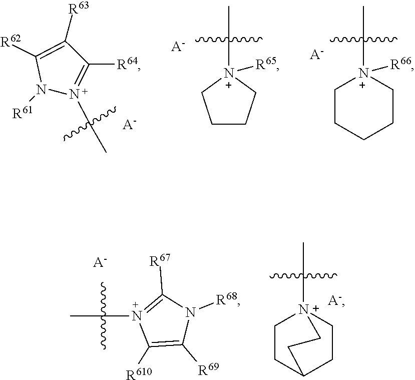
wherein R⁶¹ to R⁶¹⁰ are independently selected from hydrocarbyl groups having 1-20 carbon atoms, and the counter ion A is selected from one or more of halide ions, a methyl sulfate ion, a hydroxide ion, or a bicarbonate ion;
wherein the central unit of the alkali-stable poly(arylene alkylene piperidinium) cationic polymers having branched structures is connected to the linear unit L₁ of the alkali-stable poly(arylene alkylene piperidinium) cationic polymers having branched structures, and the central unit comprising the MA unit and the piperidinium group (m-DMP) has a structural formula shown as follows: 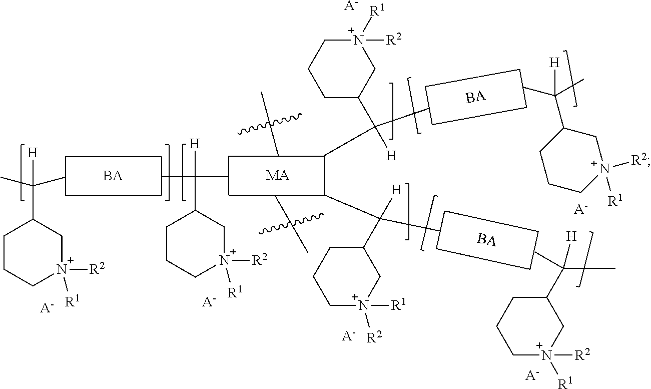
or,
wherein the linear unit L₁ of the highly alkali-stable poly(arylene alkylene piperidinium) cationic polymers having branched structures is connected to the central unit and the linear unit L₂ of the highly alkali-stable poly(arylene alkylene piperidinium) cationic polymers having branched structures, and wherein the central unit comprising the MA unit, the piperidinium group (m-DMP) and the CA unit has a structural formula shown as follows:

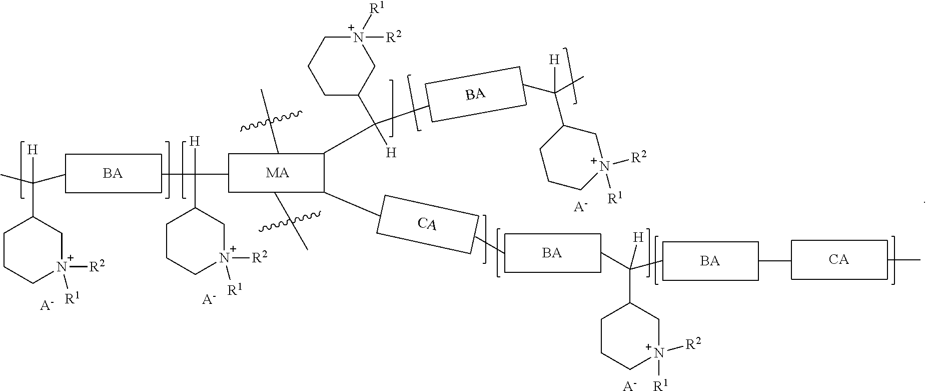

2. A preparation method of the alkali-stable poly(arylene alkylene piperidinium) cationic polymers having branched structures according to claim 1, comprising the following steps:
S1, mixing raw materials MA′, 1-R⁷ piperidine-3-formaldehyde or salt or a hydrate of 1-R⁷ piperidine-3-formaldehyde, and BA′, dissolving or dispersing the raw materials in the first organic solvent, and performing polycondensation reaction under catalysis of an organic strong acid at −20-100° C. for 0.1 h to 200 h to obtain a solution or a dispersion of a polyaromatic polymer precursor containing piperidine moieties, wherein
BA′ is independently selected from one or more of the following structures: 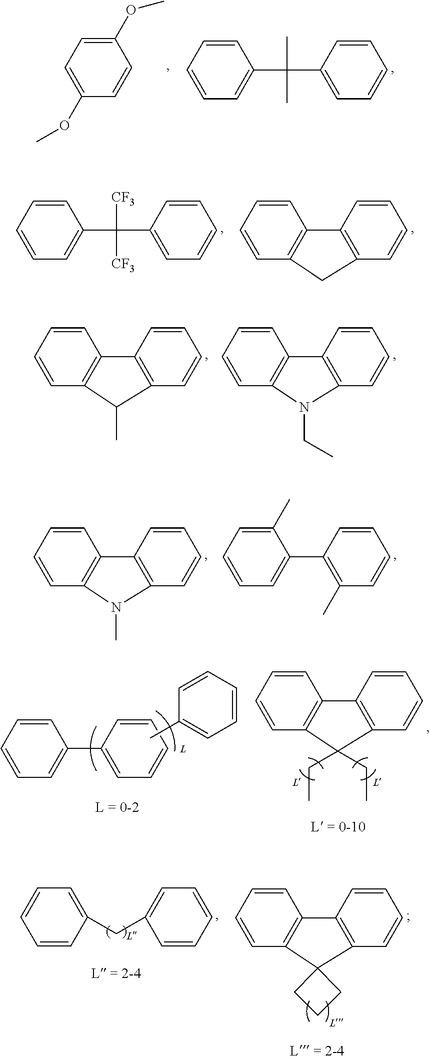
and
wherein the 1-R⁷ piperidine-3-formaldehyde structure is 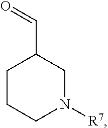
and is selected from one or more of the following structures: 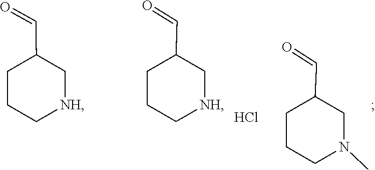
S2, dropwise adding the solution or the dispersion of the polyaromatic polymer precursor containing piperidine moieties obtained in S1 into the first precipitant slowly, filtering a precipitate after precipitation to obtain a fibrous polymer, washing the fibrous polymer completely, and drying to obtain a polyaromatic polymer precursor containing piperidine moieties;
S3, dispersing or dissolving the polyaromatic polymer precursor containing piperidine moieties obtained in S2 in a second organic solvent, adding quaternization reagents into the mixture, and then performing quaternization reaction at 0° C. to 100° C. for 0.1 h to 200 h to obtain a solution or a dispersion of alkali-stable poly(arylene alkylene piperidinium) cationic polymers having branched structures; and
S4, slowly adding the solution or the dispersion of the alkali-stable poly(arylene alkylene piperidinium) cationic polymers having branched structures obtained in S3 into a second precipitant, and filtering and drying the precipitate after precipitation to obtain the alkali-stable poly(arylene alkylene piperidinium) cationic polymers having branched structures.

3. A preparation method of the alkali-stable poly(arylene alkylene piperidinium) cationic polymers having branched structures according to claim 1, comprising:
S1, dissolving or dispersing raw materials MA′, 1-R⁷ piperidine-3-formaldehyde or salt or a hydrate of 1-R⁷ piperidinium-3-formaldehyde, BA′ and a compound CA″ in the first organic solvent, and performing polycondensation reaction under catalysis of an organic strong acid at −20° C. to 100° C. for 0.1 h to 200 h to obtain a solution or a dispersion of a polyaromatic polymer precursor containing piperidine moieties, wherein
the 1-R⁷ piperidine-3-formaldehyde structure is 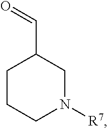
and is selected from one or more of the following structures: 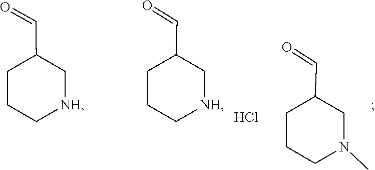
and
wherein the compound CA″ is one or more of 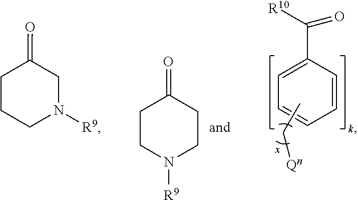
wherein R⁹ is independently selected from a hydrogen atom or a hydrocarbyl group having 1-20 carbon atoms;
wherein k=0 or 1; x=0 to 12;
wherein each R¹⁰ is independently selected from a hydrogen atom or a hydrocarbyl group having 1-20 carbon atoms, or a fully or partially fluorinated alkyl group having 1-6 carbon atoms; and
wherein Q″ is selected from one or more of a hydrogen atom or a halogen atom;
S2, dropwise adding the solution or the dispersion of the polyaromatic polymer precursor containing piperidine moieties obtained in S1 into the first precipitant slowly, filtering a precipitate after precipitation to obtain a fibrous polymer, washing the fibrous polymer completely, and drying same to obtain a polyaromatic polymer precursor containing piperidine moieties;
S3, dispersing or dissolving the polyaromatic polymer precursor containing piperidine moieties obtained in S2 in a second organic solvent, adding quaternization reagents into the mixture, and then performing quaternization reaction at 0° C. to 100° C. for 0.1 h to 200 h to obtain a solution or a dispersion of alkali-stable poly(arylene alkylene piperidinium) cationic polymers having branched structures; and
S4, slowly adding the solution or the dispersion of the alkali-stable poly(arylene alkylene piperidinium) cationic polymers having branched structures obtained in S3 into a second precipitant, and filtering and drying a precipitate after precipitation to obtain the alkali-stable poly(arylene alkylene piperidinium) cationic polymers having branched structures.

4. A method of using the alkali-stable poly(arylene alkylene piperidinium) cationic polymers having branched structures according to claim 1, wherein the alkali-stable poly(arylene alkylene piperidinium) cationic polymers having branched structures are used for preparing an anion exchange membrane or a catalyst layer binder.
